(19) United States
(12) Patent Application Publication
(10) Pub. No.: US 2026/0007970 A1
(43) Pub. Date: Jan. 8, 2026

(54) VIRTUAL OBJECT TRANSFORMATION

(71) Applicant: TENCENT TECHNOLOGY (SHENZHEN) COMPANY LIMITED, Shenzhen (CN)

(72) Inventor: Yunpeng GUO, Shenzhen (CN)

(73) Assignee: TENCENT TECHNOLOGY (SHENZHEN) COMPANY LIMITED, Shenzhen, GD (CN)

(21) Appl. No.: 19/324,023

(22) Filed: Sep. 9, 2025

Related U.S. Application Data
(63) Continuation of application No. PCT/CN2024/098711, filed on Jun. 12, 2024.

(30) Foreign Application Priority Data
Aug. 22, 2023 (CN) 202311065334.2

(51) Int. Cl. A63F 13/55

(52) U.S. Cl. CPC A63F 13/55

(57) ABSTRACT

In a method for interaction in a virtual environment, a first virtual object controlled by a first account is output for display in the virtual environment. When a second virtual object controlled by a second account is not present in the virtual environment and an object transformation instruction is received, the first virtual object is transformed into the second virtual object based on the object transformation instruction. Based on an interaction instruction directed to the second virtual object controlled by the first account, the second virtual object is controlled to interact with a third virtual object in the virtual environment.

### RELATED APPLICATIONS

The present application is a continuation of International Application No. PCT/CN2024/098711, filed on Jun. 12, 2024, which claims priority to Chinese Patent Application No. 202311065334.2, filed on Aug. 22, 2023. The entire disclosures of the prior applications are hereby incorporated by reference.

### FIELD OF THE TECHNOLOGY

This application relates to the technical field of virtualization and human-computer interaction, including an interaction method for a virtual scene.

### BACKGROUND OF THE DISCLOSURE

In related games, some high-level players do not have much game time and have no time to participate in many battles that occur in the games. Consequently, resource utilization and human-computer interaction efficiency in the games are relatively low.

### SUMMARY

Aspects of this disclosure provide an interaction method for a virtual scene, an interaction apparatus, and a non-transitory computer-readable storage medium, which can improve resource utilization and human-computer interaction efficiency.

Examples of technical solutions of this disclosure may be implemented as follows:

An aspect of this disclosure provides a method for interaction in a virtual environment. In the method, a first virtual object controlled by a first account is output for display in the virtual environment. When a second virtual object controlled by a second account is not present in the virtual environment and an object transformation instruction is received, the first virtual object is transformed into the second virtual object based on the object transformation instruction. Based on an interaction instruction directed to the second virtual object controlled by the first account, the second virtual object is controlled to interact with a third virtual object in the virtual environment.

An aspect of this disclosure provides an apparatus for interaction in a virtual environment. The apparatus includes processing circuitry configured to output for display, in the virtual environment, a first virtual object controlled by a first account. When a second virtual object controlled by a second account is not present in the virtual environment and an object transformation instruction is received, the processing circuitry is configured to transform the first virtual object into the second virtual object based on the object transformation instruction. Based on an interaction instruction directed to the second virtual object controlled by the first account, the processing circuitry is configured to control the second virtual object to interact with a third virtual object in the virtual environment.

An aspect of this disclosure provides an interaction method for a virtual scene, including: displaying, in a virtual scene, a first virtual object controlled by a first account; changing, when a second virtual object controlled by a second account does not exist in the virtual scene, the first virtual object controlled by the first account to the second virtual object in response to an object change instruction; and controlling, in response to an interaction instruction for the second virtual object controlled by the first account, the second virtual object to interact with another virtual object, the another virtual object being a virtual object other than the first virtual object and the second virtual object in the virtual scene.

An aspect of this disclosure provides an interaction apparatus for a virtual scene, including: a display module, configured to display, in a virtual scene, a first virtual object controlled by a first account; a change module, configured to change, when a second virtual object controlled by a second account does not exist in the virtual scene, the first virtual object controlled by the first account to the second virtual object in response to an object change instruction; and a control module, configured to control, in response to an interaction instruction for the second virtual object controlled by the first account, the second virtual object to interact with another virtual object, the another virtual object being a virtual object other than the first virtual object and the second virtual object in the virtual scene.

An aspect of this disclosure provides an electronic device, including: a memory, configured to store a computer-executable instruction; and a processor, configured to: when executing the computer-executable instruction stored in the memory, implement the interaction method for a virtual scene provided by the aspects of this disclosure.

An aspect of this disclosure provides a non-transitory computer-readable storage medium storing instructions which, when executed by a processor, cause the processor to implement the interaction method for a virtual scene provided in the aspects of this disclosure.

An aspect of this disclosure provides a computer program product or a computer program, the computer program product or the computer program including computer-executable instructions, the computer-executable instructions being stored in a computer-readable storage medium, and a processor of an electronic device reading the computer-executable instructions from the computer-readable storage medium, and executing the computer-executable instructions, so that the electronic device performs the interaction method for a virtual scene provided in the aspects of this disclosure.

The aspects of this disclosure have the following beneficial effects:

When the second virtual object controlled by the second account does not exist in the virtual scene, the first virtual object controlled by the first account is changed to the second virtual object, so that the first account controls the second virtual object to interact with another virtual object. In this way, the first virtual object controlled by the first account is changed to the second virtual object, and the first account replaces the second account to control the second virtual object to interact with another virtual object, thereby not only enriching an interaction process of players and improving diversity of interaction manners in the virtual scene and resource utilization in the virtual scene, but also improving human-computer interaction efficiency and hardware resource utilization of an electronic device.

### BRIEF DESCRIPTION OF THE DRAWINGS

FIG. 1 is a schematic architectural diagram of an interaction system 100 for a virtual scene according to an aspect of this disclosure;

FIG. 2 is a schematic structural diagram of an electronic device according to an aspect of this disclosure;

FIG. 3 is a schematic flowchart of an interaction method for a virtual scene according to an aspect of this disclosure;

FIG. 4 is a schematic diagram of a first virtual object, a second virtual object, and change countdown according to an aspect of this disclosure;

FIG. 5 is a schematic diagram of a change identifier according to an aspect of this disclosure;

FIG. 6 is a schematic diagram of display of an object presentation interface according to an aspect of this disclosure;

FIG. 7 is a schematic diagram of display of an object presentation interface according to an aspect of this disclosure;

FIG. 8 is a schematic diagram of a change removing control according to an aspect of this disclosure;

FIG. 9 is a schematic diagram of an interaction parameter detail interface according to an aspect of this disclosure;

FIG. 10 is a schematic diagram of an object presentation interface and an object setting interface according to an aspect of this disclosure;

FIG. 11 is a schematic diagram of object information of a first virtual object according to an aspect of this disclosure;

FIG. 12 is a schematic diagram of a virtual backpack of a first virtual object according to an aspect of this disclosure;

FIG. 13 is a schematic diagram of display of a menu that corresponds to a first virtual object and includes at least one operation control according to an aspect of this disclosure;

FIG. 14 is a schematic diagram of display of at least one interaction control corresponding to a third virtual object according to an aspect of this disclosure;

FIG. 15 is a schematic flowchart in which a changing player performs incarnation according to an aspect of this disclosure; and

FIG. 16 is a schematic flowchart in which a changing player removes incarnation according to an aspect of this disclosure.

### DETAILED DESCRIPTION

To make the objectives, technical solutions, and advantages of this disclosure clearer, the following describes aspects of this disclosure in further detail with reference to the accompanying drawings. The described aspects are not to be considered as limitation on the aspects of this disclosure. Other aspects shall fall within the scope of this disclosure. The descriptions of the terms are provided as examples only and are not intended to limit the scope of the disclosure.

In the following descriptions, related “some aspects” describe a subset of all possible aspects. However, the “some aspects” may be the same subset or different subsets of all the possible aspects, and may be combined with each other without conflict.

The term “first/second/third” involved in the following descriptions is merely used to distinguish between similar objects and does not denote specific order of objects. Specific order or sequence of the term “first/second/third” can be interchanged where permitted such that the aspects of this disclosure described herein can be implemented in order other than that illustrated or described herein.

Unless otherwise defined, meanings of all technical and scientific terms used in this specification are the same as those usually understood by a person skilled in the art to which this disclosure belongs. Terms used herein are merely intended to describe examples of the aspects of this disclosure, and are not intended to limit this disclosure.

Before the aspects of this disclosure are further described in detail, an example description is made on nouns and terms in the aspects of this disclosure, and the nouns and terms in the aspects of this disclosure are applicable to the following explanations.

(1) Third-person perspective: A third-person perspective is a perspective in which an in-game camera is located at a specific distance behind a player-controlled character, so that the character and all battle elements in a specific surrounding environment can be seen in an image.

(2) In response to: used to indicate a condition or a state on which an operation to be executed depends. When the condition or state on which an operation to be executed depends is satisfied, one or more operations to be executed may be performed in real time or with a specified delay. Unless otherwise specified, there is no restriction on the sequence in which a plurality of operations to be executed are performed.

(3) Virtual scene: virtual scene displayed (or provided) when an application program runs on a terminal. The virtual scene can be a simulation environment of the real world, a semi-simulation and semi-fictitious virtual environment, or a purely fictitious virtual environment. The virtual scene may be any one of a two-dimensional virtual scene, a 2.5-dimensional virtual scene, or a three-dimensional virtual scene.

For example, the virtual scene may include sky, land, ocean, and the like. The land may include environmental elements such as desert and city, and a user may control a virtual object to perform an activity in the virtual scene. The activity includes, but is not limited to: at least one of adjusting a body posture, crawling, walking, running, riding, jumping, driving, picking, shooting, attacking, and throwing. The virtual scene may be displayed from a first-person perspective (for example, a virtual object in a game is played from the perspective of a user), or the virtual scene may be displayed from a third-person perspective (for example, the user chases the virtual object in the game to play the game), or the virtual scene may be displayed from a bird's-eye perspective. The perspectives may be switched between each other.

(4) Virtual object, that is, characters of various persons and objects that can interact in a virtual scene, or movable objects in a virtual scene. The movable objects may be a virtual character, a virtual animal, an animation character, and the like, for example, people, animals, plants, oil drums, walls, and stones displayed in the virtual scene. The virtual object may be a virtual image used for representing a user in the virtual scene. The virtual scene may include a plurality of virtual objects, and each virtual object has a shape and a volume in the virtual scene, and occupies some space in the virtual scene.

For example, the virtual object may be a user character controlled through an operation on a client, may be artificial intelligence (AI) deployed in a virtual scene for fight through training, or may be a non-player character (NPC) deployed in a virtual scene for interaction. A number of virtual objects participating in the interaction in the virtual scene may be preset or dynamically determined based on a number of interactive clients.

(5) Client: A client is also referred to as a user client and is a program that corresponds to a server and that provides a local service to a user. In addition to some application programs that can only run locally, the client is installed on an ordinary user device and needs to cooperate with the server to run. In other words, the client requires a corresponding server and service program in a network to provide a corresponding service. In this way, a specific communication connection needs to be established on the client and a server side, to ensure a normal operation of an application program, for example, a game client.

(6) Scenario data: Scenario data represents characteristic data of a virtual scene, and may be, for example, an area of a construction region in the virtual scene and a current architectural style of the virtual scene, and may also include a position of a virtual architecture in the virtual scene and a floor area of the virtual architecture.

(7) Account: An account is an identifier used by a player in a game, usually includes a user name and a password, and sometimes may further include other information such as an email address and a mobile phone number, and is used for distinguishing different players in the game.

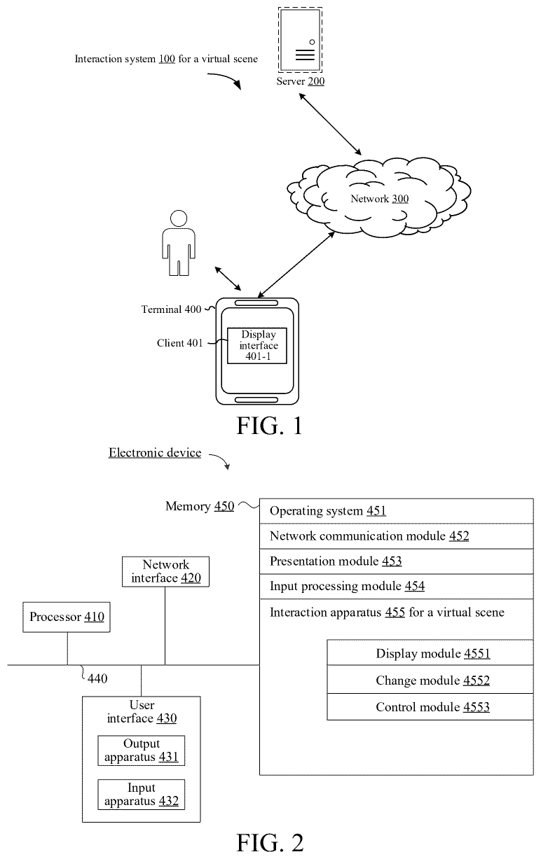

FIG. 1 is a schematic architectural diagram of an interaction system 100 for a virtual scene according to an aspect of this disclosure, to implement an interaction application scenario in a virtual scene (for example, the interaction application scenario in the virtual scene can be an interaction application scenario based on a virtual scene in a game APP, for example, when a player plays in the game APP and finds that a high-level player is not online, a virtual object controlled by the player is changed to a virtual object corresponding to the high-level player, to control the virtual object corresponding to the high-level player to play the game). A terminal (illustrated as a terminal 400) is connected to a server 200 through a network 300, and the network 300 can be a wide area network, or a local area network, or a combination thereof. The terminal 400 is used by a user to use a client 401, and a display interface (illustrated as a display interface 401-1) performs display. The terminal 400 and the server 200 are connected to each other through a wired or wireless network.

The terminal 400 is configured to send, to the server 200, a scene data obtaining request of a virtual scene including a first virtual object controlled by a first account.

The server 200 is configured to send, to the terminal 400 based on the received scene data obtaining request, scene data of the virtual scene including the first virtual object controlled by the first account.

The terminal 400 is further configured to receive the scene data of the virtual scene including the first virtual object controlled by the first account; display the virtual scene based on the scene data and display, in the virtual scene, the first virtual object controlled by the first account; change, when a second virtual object controlled by a second account does not exist in the virtual scene, the first virtual object controlled by the first account to the second virtual object in response to an object change instruction; and control, in response to an interaction instruction for the second virtual object controlled by the first account, the second virtual object to interact with another virtual object, where the another virtual object is a virtual object other than the first virtual object and the second virtual object in the virtual scene.

In some aspects, the server 200 may be an independent physical server, or may be a server cluster formed by a plurality of physical servers or a distributed system, and may further be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal 400 may be a smartphone, a tablet computer, a notebook computer, a desktop computer, a set-top box, an intelligent voice interactive device, a smart home appliance, a virtual reality device, an on-board terminal, an aircraft, a mobile device (for example, a mobile phone, a portable music player, a personal digital assistant, a dedicated messaging device, a portable game device, a smart speaker, and a smartwatch), or the like, but is not limited thereto. The terminal may be connected directly or indirectly to the server in a wired or wireless communication manner, which is not limited in this aspect of this disclosure.

The following describes an electronic device that implements an interaction method for a virtual scene according to an aspect of this disclosure. FIG. 2 is a schematic structural diagram of an electronic device according to an aspect of this disclosure. The electronic device may be a server or a terminal. For example, the electronic device is the terminal shown in FIG. 1 and the electronic device shown in FIG. 2 includes: at least one processor 410, a memory 450 (for example, a non-transitory computer-readable storage medium), at least one network interface 420, and a user interface 430. Various components of the terminal 400 are coupled by using a bus system 440. The bus system 440 is configured to enable connected communication between these components. In addition to a data bus, the bus system 440 further includes a power bus, a control bus, and a state signal bus. However, for clarity, various buses are marked as the bus system 440 in FIG. 2.

Processing circuitry, such as the processor 410, may be an integrated circuit chip with a signal processing capability, such as a general-purpose processor, a digital signal processor (DSP), or another programmable logic device, a discrete gate or transistor logic device, or a discrete hardware component. The general-purpose processor may be a microprocessor, any conventional processor, or the like.

The user interface 430 includes one or more output apparatuses 431 that can display media content, and includes one or more speakers and/or one or more visual display screens. The user interface 430 further includes one or more input apparatuses 432, and includes user interface components that facilitate user input, such as a keyboard, a mouse, a microphone, a touch display screen, a camera, and other input buttons and controls.

The memory 450 may be a removable memory, a non-removable memory, or a combination thereof. Examples of hardware devices include a solid-state memory, a hard disk drive, an optical disk drive, and the like. In some aspects, the memory 450 includes one or more storage devices physically located away from the processor 410.

The memory 450 may be a volatile memory or a non-volatile memory, or may include both a volatile memory and a non-volatile memory. The non-volatile memory may be a read only memory (ROM), and the volatile memory may be a random access memory (RAM). The memory 450 described in this aspect of this disclosure aims to include any suitable type of memory.

In some aspects, the memory 450 can store data to support various operations, and examples of the data include programs, modules, data structures, or subsets or supersets thereof, as described below.

An operating system 451 includes system programs, for example, a framework layer, a core library layer, and a driver layer configured to process various basic system services and perform hardware-related tasks, and is configured to implement various basic services and process hardware-based tasks.

A network communication module 452 is configured to reach another electronic device through one or more (wired or wireless) network interfaces 420. For example, the network interface 420 includes: Bluetooth, Wi-Fi, a universal serial bus (USB), and the like.

A presentation module 453 is configured to enable display of information through the one or more output apparatuses 431 (for example, a display screen and a speaker) associated with the user interface 430.

An input processing module 454 is configured to detect one or more user inputs or interactions from the input apparatuses 432 and translate the detected inputs or interactions.

In some aspects, an apparatus provided in this aspect of this disclosure may be implemented by software. FIG. 2 shows an interaction apparatus 455 for a virtual scene stored in the memory 450, and the apparatus may be software in the form of programs and plug-ins, including the following software modules: a display module 4551, a change module 4552, and a control module 4553. The modules are logical, and therefore may be combined or further split in any manner based on implemented functions. Functions of the modules are described below.

In some other aspects, the apparatus provided in the aspects of this disclosure may be implemented by hardware. For example, the interaction apparatus for a virtual scene provided in the aspects of this disclosure may be a processor in the form of a hardware decoding processor, and is programmed to perform the interaction method for a virtual scene provided in aspects of this disclosure. For example, the processor in the form of the hardware decoding processor may be one or more application specific integrated circuits (ASIC), DSPs, programmable logic devices (PLD), complex programmable logic devices (CPLD), field-programmable gate arrays (FPGA), or other electronic components.

In some aspects, the terminal or the server may implement the method for interaction in a virtual scene provided in aspects of this disclosure by running a computer program. For example, the computer program may be an original program or a software module in an operating system; A computer program may be a native application (APP), that is, a program that needs to be installed in an operating system to run, such as an instant messaging APP, and a web browser APP; or can be a mini program, that is, a program that only needs to be downloaded to a browser environment to run. or may be a mini program that can be embedded in any APP. In conclusion, the computer program can be any form of application program, module, or plug-in.

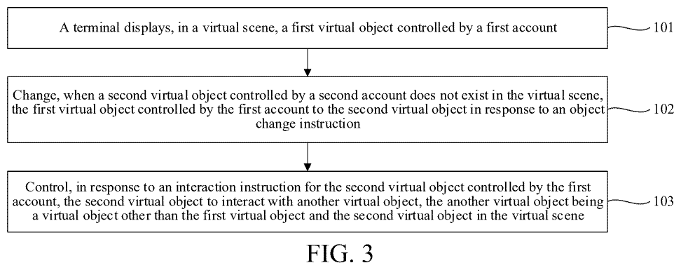

Based on the foregoing descriptions of the interaction system for a virtual scene and the electronic device provided in this aspect of this disclosure, the following describes the interaction method for a virtual scene provided in aspects of this disclosure. In actual implementation, the interaction method for a virtual scene provided in the aspects of this disclosure may be implemented by a terminal or a server alone, or may be implemented by the terminal and the server collaboratively. For example, the terminal 400 in FIG. 1 performs the interaction method for a virtual scene provided in the aspects of this disclosure alone. FIG. 3 is a schematic flowchart of an interaction method for a virtual scene according to an aspect of this disclosure. The method is described with reference to operations shown in FIG. 3.

Operation 101: A terminal displays, in a virtual scene, a first virtual object controlled by a first account. For example, a first virtual object controlled by a first account is output for display in the virtual environment.

In actual implementation, an application that supports a virtual scene is installed on the terminal. The application program may be any one of a first-person shooting game, a third-person shooting game, a multiplayer online battle arena game, a virtual reality application program, a three-dimensional map program, or a multiplayer gunfight survival game. A user may use the terminal to operate a virtual object in the virtual scene to perform an activity.

When a user opens the client (for example, the terminal device receives a click operation performed by the user on an icon corresponding to a role-playing game APP presented on a desktop) installed on the terminal device, and the terminal device runs the client, the virtual scene may be displayed on a human-computer interaction interface of the client. The virtual scene may include the first virtual object.

In some other aspects, the human-computer interaction interface of the client may display the virtual scene from a first-person perspective (for example, the virtual object in the game is played from the perspective of the user), or may display the virtual scene from a third-person perspective (for example, the user chases the virtual object in the game to play the game), or display the virtual scene from a bird's-eye perspective. The foregoing different perspectives may be switched.

For example, the first virtual object may be an object controlled by a current user in a game. The virtual scene may also include another virtual object, for example, a second virtual object that may be controlled by another user or by a robot program.

For example, the virtual scene is displayed from a first-person perspective. The displaying a virtual scene in a human-computer interaction interface may include: determining a field of view region of the first virtual object based on a viewing position and a viewing angle range (that is, angles at which the first virtual object can observe the virtual scene from different directions) of the first virtual object in a full virtual scene, and displaying a partial virtual scene located in the field of view region in the full virtual scene, that is, the displayed virtual scene may be the partial virtual scene relative to a panoramic virtual scene. Because the first-person perspective is the most impactful viewing perspective for users, users can achieve immersive perception during the operation.

For example, a virtual scene is displayed from a bird's-eye perspective. The displaying a virtual scene in a human-computer interaction interface may include: in response to a scaling operation on the panoramic virtual scene, presenting a partial virtual scene corresponding to the scaling operation in the human-computer interaction interface, that is, the displayed virtual scene may be a partial virtual scene relative to the panoramic virtual scene. In this way, operability of the user during operation can be improved, thereby improving the efficiency of human-computer interaction.

The first account herein indicates an account used by a current user to log into the client. Different users correspond to different accounts. An account is equivalent to an identifier of a user. There is a correspondence between an account and a virtual object controlled by the account. For example, a first user logs into the client by using a first account to control the first virtual object, and a second user logs into the client by using a second account to control the second virtual object. The first user cannot log into the client by using the first account to control the second virtual object, but can log into the client by using the second account to control the second virtual object.

Operation 102: Change, when a second virtual object controlled by a second account does not exist in the virtual scene, the first virtual object controlled by the first account to the second virtual object in response to an object change instruction. For example, when a second virtual object controlled by a second account is not present in the virtual environment and an object transformation instruction is received, the first virtual object is transformed into the second virtual object based on the object transformation instruction.

The first virtual object and the second virtual object are in a cooperative relationship, and an interaction success rate corresponding to the second virtual object is higher than an interaction success rate corresponding to the first virtual object. An interaction success rate is related to at least one of a level, equipment, and an attribute value of a virtual object, that is, the interaction success rate is determined according to at least one of the level, the equipment, and the attribute value of the virtual object. The attribute value may be, for example, a damage value for another virtual object when the virtual object interacts with the another virtual object, a life value, or a defense value when the virtual object interacts with the another virtual object.

In actual implementation, that the second virtual object controlled by the second account does not exist in the virtual scene is used to indicate that no user logs into the client by using the second account to control the second virtual object in the virtual scene. That the first virtual object and the second virtual object are in the cooperative relationship is used to indicate that the first virtual object and the second virtual object are in the same camp, for example, are in the same game association or game family. Herein, the virtual scene includes a plurality of camps, each camp includes at least one virtual object, and virtual objects in different camps are in a confrontational relationship, that is, an enemy relationship.

In actual implementation, the first virtual object controlled by the first account is changed to the second virtual object, that is, transformed or replaced. That the first virtual object controlled by the first account is changed to the second virtual object is displayed in the virtual scene, that is, both a form and an interaction attribute of the first virtual object controlled by the first account are changed to a form and an interaction attribute of the second virtual object. For example, the form of the first virtual object controlled by the first account is first changed to the form of the second virtual object, and then the interaction attribute of the second virtual object is obtained, that is, an interaction attribute of the second virtual object when the second account exits the game in a case that the second virtual object is controlled by the second account most recently. Then, the interaction attribute of the second virtual object is allocated to the first virtual object whose form is changed, that is, the interaction attribute of the first virtual object whose form is changed is changed to the interaction attribute of the second virtual object. Based on this, in a case in which both the form and the interaction attribute of the first virtual object controlled by the first account are changed to the form and the interaction attribute of the second virtual object, the first virtual object controlled by the first account is changed to the second virtual object.

Herein, the form is used to indicate an appearance of an object, and the interaction attribute includes, but is not limited to, a level, a skill, combat effectiveness, and an attribute value of the virtual object, for example, damage to another virtual object when the virtual object interacts with another virtual object, and a defense value and a life value when the virtual object interacts with another virtual object.

In actual implementation, after the first virtual object controlled by the first account is changed to the second virtual object, from the perspective of appearance, it is equivalent to that the first account directly controls the second virtual object. Meanwhile, an interaction attribute of the second virtual object controlled by the first account is the same as the interaction attribute of the second virtual object controlled by the second account. That is, compared with another virtual object, the second virtual object controlled by the first account is not different from the second virtual object controlled by the second account.

In actual implementation, the interaction success rate is used to indicate a success rate of interacting with another virtual object, for example, a probability of defeating another virtual object. As described above, the interaction success rate is determined according to an interaction attribute such as a level, equipment, and an attribute value of the virtual object. For example, an interaction success rate of a virtual object with a high level is high, an interaction success rate of a virtual object with a strong skill is high, an interaction success rate of a virtual object with good equipment is high, an interaction success rate of a virtual object causing high damage to another virtual object when interacting with the another virtual object is high, and an interaction success rate of a virtual object with a high defense value when interacting with another virtual object is high.

In some aspects, after the changing the first virtual object controlled by the first account to the second virtual object in response to an object change instruction, change countdown may further be displayed, where the change countdown is used to indicate a time length in which the first account can control the second virtual object; and the second virtual object controlled by the first account is changed back to the first virtual object when the change countdown ends.

The change countdown is preset, for example, may be one hour or 10 minutes. A display position of the change countdown may also be preset, and may be, for example, displayed in an associated position of the second virtual object in the virtual scene or displayed in an associated position of the identifier of the first virtual object in the virtual scene. The identifier of the first virtual object may indicate an avatar identifier or a nickname identifier of the first virtual object, and the identifier of the first virtual object is displayed in an upper left corner of the human-computer interaction interface. The associated position of the second virtual object may indicate one of an upper position, a lower position, a left position, or a right position of the second virtual object. Similarly, the associated position of the identifier of the first virtual object may indicate one of an upper position, a lower position, a left position, or a right position of the identifier of the first virtual object.

In actual implementation, when the change countdown has not ended, the first account may control the second virtual object to interact with another virtual object, or control the second virtual object to move in the virtual scene. In this process, the change countdown is detected in real time. When a detection result indicates that the change countdown has not ended, the first account may control the second virtual object, and when the detection result indicates that the change countdown has ended, the second virtual object controlled by the first account is changed back to the first virtual object.

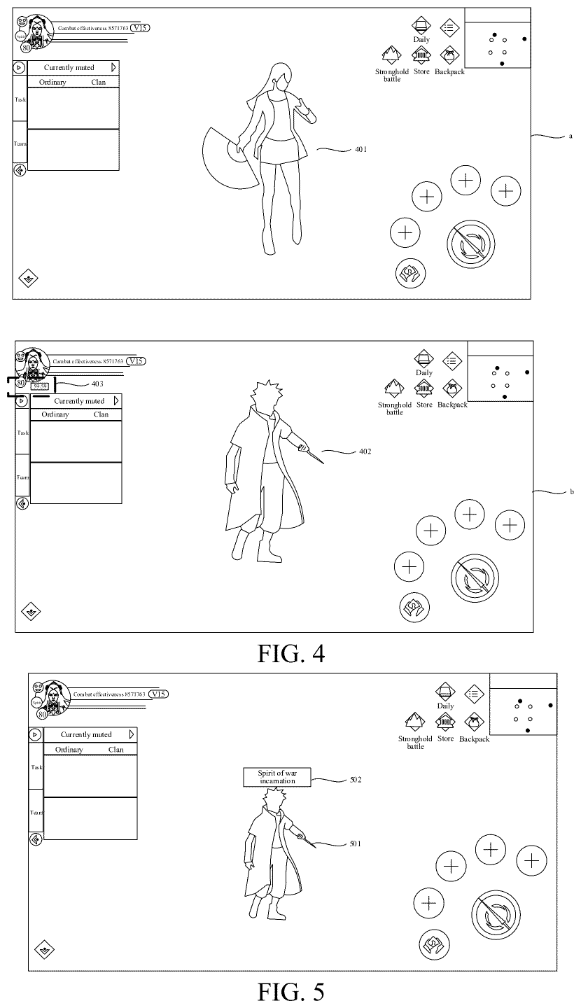

FIG. 4 is a schematic diagram of a first virtual object, a second virtual object, and change countdown according to an aspect of this disclosure. Based on FIG. 4, the first virtual object indicated by 401 is displayed in a, then in response to an object change instruction, the first virtual object controlled by the first account is changed to the second virtual object indicated by 402 in b, and change countdown indicated by a dashed-line box 403 is displayed below an avatar identifier of the first virtual object at the upper left corner in b. The second virtual object controlled by the first account is changed back to the first virtual object when the change countdown ends.

The timing for displaying the change countdown may be: the change countdown is displayed when the first virtual object controlled by the first account is changed to the second virtual object, or the change countdown is displayed only when it is detected in a process in which the first account controls the second virtual object that a time length in which the first account can still control the second virtual object is the same as a time length of the change countdown based on a preset time length of the change countdown. This is not limited in this aspect of this disclosure.

In this way, by setting the change countdown, other virtual objects can be changed to the second virtual object, thereby improving an interaction frequency, resource utilization, and human-computer interaction efficiency in the virtual scene. In addition, the user of the first account can promptly sense a time in which the second virtual object can still be controlled, to help the user of the first account perform interaction planning, thereby further improving resource utilization and human-computer interaction efficiency in the virtual scene.

In some aspects, before the changing the first virtual object controlled by the first account to the second virtual object in response to an object change instruction, a first change time length may further be displayed, where the first change time length is used to indicate an accumulated time length for changing to the second virtual object in a target time period. Therefore, a process of changing the first virtual object controlled by the first account to the second virtual object in response to the object change instruction may be: changing the first virtual object controlled by the first account to the second virtual object in response to the object change instruction when the first change time length is less than a target change time length.

The target change time length is a maximum accumulated time length in which the second virtual object can be controlled by at least one account other than the second account in the target time period, and may be preset, for example, may be one hour or two hours. The target time period may also be preset, for example, may be one day or one week. The accumulated time length for changing to the second virtual object in the target time period indicates a sum of time lengths in which the at least one account other than the second account changes a virtual object controlled by the at least one account to the second virtual object in the target time period. For example, a time length of controlling the second virtual object when each another account changes a virtual object controlled by the another account to the second virtual object is obtained in the target time period in response to the object change instruction; and time lengths of controlling are added to obtain a sum of the time lengths of controlling the second virtual object by the at least one other account, so as to determine the sum of the time lengths of controlling as the accumulated time length for changing to the second virtual object in the target time period, that is, the first change time length. Further, when the first change time length is less than the target change time length, the first virtual object controlled by the first account is changed to the second virtual object.

By applying the foregoing aspect, the first virtual object controlled by the first account can be changed to the second virtual object only when the first change time length is less than the target change time length. In this way, whether a virtual object controlled by an account in the virtual scene can be changed is restricted, avoiding unrestricted change for a virtual object and ensuring fairness of the game, and improving the possibility that another virtual object in the virtual scene can be changed, that is, improving resource utilization.

In actual implementation, first change failure information may be further displayed in response to the object change instruction when the first change time length reaches the target change time length; where the first change failure information is used to indicate that the accumulated time length for changing to the second virtual object in the target time period has reached a maximum accumulated time length.

The first change failure information may be text information, for example, “an accumulated time length for changing to the virtual object has reached a maximum accumulated time length, please select another virtual object for change”, or may be directly “change fails”, or may be image information. This is not limited in this aspect of this disclosure.

In actual implementation, when the object change instruction for the second virtual object is received, the first change time length corresponding to the second virtual object is obtained, then the first change time length is compared with the target change time length, and when a comparison result indicates that the first change time length does not reach the target change time length, it is determined that the first virtual object can be changed to the second virtual object, so as to change the first virtual object controlled by the first account to the second virtual object. When the comparison result indicates that the first change time length reaches the target change time length, it is determined that the first virtual object cannot be changed to the second virtual object, so that the first change failure information is displayed.

In an actual application, when the first change time length reaches the target change time length, the first virtual object cannot be changed to the second virtual object. In this way, the first account may change the first virtual object to another virtual object, thereby improving the possibility that another virtual object in the virtual scene can be changed, and improving the resource utilization and the human-computer interaction efficiency in the virtual scene.

In actual implementation, when the first change time length reaches the target change time length, a change time length may further be exchanged for. The maximum accumulated time length for changing to the second virtual object in the target time period, that is, the target change time length may be increased based on a virtual asset. For example, change time lengths that can be increased by are different for different virtual assets of virtual objects, and the virtual asset of the virtual object has a correspondence with a change time length that can be increased by. Alternatively, the maximum accumulated time length for changing to the second virtual object in the target time period, that is, the target change time length is increased based on a level of a virtual object. For example, change time lengths that can be increased by are different for different levels of virtual objects, and the level of the virtual object has a correspondence with the change time length that can be increased by. Based on this, a change time length that can be increased by is determined based on the virtual asset of the virtual object and a correspondence between the virtual asset and a change time length that can be increased by. Alternatively, the change time length that can be increased by is determined based on a level of a virtual object and a correspondence between a level and a target change time length that can be increased by.

The increased target change time length may be for only a virtual object corresponding to an account that initiates the exchange operation of virtual asset or level exchange, or may be for any virtual object in a cooperative relationship with the second virtual object. This is not limited in this aspect of this disclosure.

For example, when the target change time length for changing to the second virtual object in the target time period is one hour, when the first change time length reaches one hour, the target change time length may be increased to two hours by using gold coins, thereby increasing an accumulated time length for changing to the second virtual object in the target time period.

In some aspects, after the changing the first virtual object controlled by the first account to the second virtual object in response to an object change instruction, the second virtual object controlled by the first account may further be displayed in the virtual scene, and a change identifier may be displayed in an associated position of the second virtual object controlled by the first account; where the change identifier is used to prompt that the second virtual object is not controlled by the second account.

The associated position of the second virtual object may indicate one of an upper position, a lower position, a left position, and a right position of the second virtual object, and the change identifier may be a text identifier, a graphic identifier, or the like. For example, when the change identifier is a text identifier, text content may be “being incarnating”, “incarnation of spirit of war”, or the like. Therefore, the change identifier prompts another virtual object of virtual objects that the currently displayed second virtual object is not controlled by the second account, and instead is controlled by an account other than the second account.

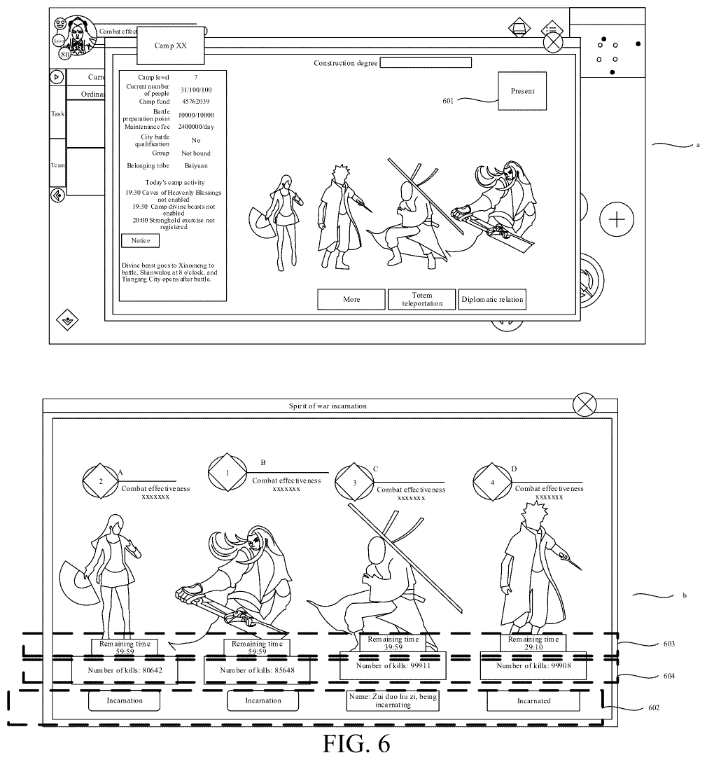

FIG. 5 is a schematic diagram of a change identifier according to an aspect of this disclosure. Based on FIG. 5, a change identifier indicated by 502 is displayed above the second virtual object indicated by 501.

By applying the foregoing aspect, in an interaction process of a virtual scene, the change identifier prompts another virtual object that an account that controls a corresponding virtual object is not an original account, avoiding that the current account that controls the virtual object needs to indicate, to another virtual object, that the current account is not the original account, thereby improving human-computer interaction efficiency and hardware resource utilization of an electronic device.

In some aspects, after the changing the first virtual object controlled by the first account to the second virtual object in response to an object change instruction, recovery countdown may be further displayed when a status of the second account switches from a not-logged-in status to a logged-in status, where the recovery countdown is used to indicate a time length still required to change the second virtual object back to the first virtual object; and the second virtual object controlled by the first account is changed back to the first virtual object when the recovery countdown ends.

The logged-in status of the second account is used to indicate that a user logs into, by using the second account, a client corresponding to the virtual scene, and the not-logged-in status of the second account is used to indicate that no user logs into, by using the second account, a client corresponding to the virtual scene.

In actual implementation, when the status of the second account is switched from the not-logged-in status to the logged-in status, recovery countdown used to instruct to change the second virtual object back to the first virtual object is displayed. The recovery countdown herein is preset, and may be, for example, three seconds or five seconds. The recovery countdown may be displayed in the middle of the human-computer interaction interface to prompt the user in time.

In this way, in a process in which the second virtual object controlled by the first account interacts with another virtual object, the recovery countdown prompts in time the user that the second virtual object is to be changed back to the first virtual object, so that the user exits the process of interacting with another virtual object.

In some aspects, the virtual scene includes at least two virtual spaces, that is, a first virtual space and a second virtual space. In this case, the displaying, in the virtual scene, the first virtual object controlled by the first account may be: displaying, in the first virtual space of the virtual scene, the first virtual object controlled by the first account. Therefore, a process of changing the first virtual object controlled by the first account to the second virtual object in response to the object change instruction may be: detecting the first virtual space in response to the object change instruction; and changing the first virtual object controlled by the first account to the second virtual object when a detection result indicates that the first virtual space satisfies an object change condition of the first virtual object.

The at least two virtual spaces included in the virtual scene are preset, and belong to the same virtual scene. For example, the first virtual space and the second virtual space may be set to virtual spaces such as a desert, an ocean, a castle, or a jungle. This is not limited in this aspect of this disclosure. Meanwhile, different virtual spaces correspond to different maps, and a virtual object in the virtual scene may move in different virtual spaces.

In an actual application, by limiting that a virtual object controlled by an account can be changed only in a particular region, balance of the game is ensured and resource utilization is improved.

In practical implementation, when receiving the object change instruction, the first virtual space in which the first virtual object is located is detected, and the first virtual object controlled by the first account is changed to the second virtual object when a detection result indicates that the first virtual space satisfies an object change condition of the first virtual object.

For a plurality of virtual spaces included in the virtual scene, some virtual spaces support object change and some virtual spaces do not support object change. The object change condition herein is used to indicate whether a current virtual space supports object change. Satisfying the object change condition means that the current virtual space supports object change, and failing to satisfy the object change condition means that the current virtual space does not support object change. Therefore, that the first virtual space satisfies the object change condition of the first virtual object is used to indicate that the first virtual space is set as a virtual space supporting object change.

In actual implementation, when the detection result indicates that the first virtual space does not satisfy the object change condition of the first virtual object, change failure prompt information is displayed. The change failure prompt information is used to indicate that the first virtual space is set as a virtual space that does not support object change. As a result, the first virtual object controlled by the first account cannot be changed to the second virtual object in the first virtual space.

In actual implementation, after the first virtual object controlled by the first account is changed to the second virtual object, the second virtual object may be further controlled, in response to a movement operation on the second virtual object, to move in the first virtual space. The second virtual object controlled by the first account is changed back to the first virtual object when the second virtual object moves from the first virtual space to the second virtual space and the second virtual space does not satisfy the object change condition of the first virtual object.

As described above, some virtual spaces support object change and some virtual spaces do not support object change. When the first virtual space supports object change, after the first virtual object controlled by the first account is changed to the second virtual object in the first virtual space, the second virtual object is controlled to move in the first virtual space. When the second virtual object moves from the first virtual space to the second virtual space that does not support object change, the second virtual object is automatically changed back to the first virtual object.

Before the second virtual object is automatically changed back to the first virtual object, the recovery countdown may also be displayed, so that when the recovery countdown ends, the second virtual object controlled by the first account is changed back to the first virtual object.

By applying the foregoing aspect, when a virtual object is in a virtual space supporting object change, the virtual object controlled by the account may be changed, and when the changed virtual object moves to a virtual space not supporting object change, the virtual object controlled by the account is automatically changed to an original virtual object. In this way, an interaction process in the virtual scene becomes more diverse, and a moving region of the changed virtual object is defined, so that the changed virtual object is managed conveniently, thereby improving hardware resource utilization.

In some aspects, second change failure information is displayed in response to the object change instruction when the second virtual object controlled by the second account exists in the virtual scene; where the second change failure information is used to indicate that object change fails and the second virtual object controlled by the second account exists in the virtual scene.

That the second virtual object controlled by the second account exists in the virtual scene is used to indicate that before the object change instruction is received, a user has logged into, by using the second account, the client corresponding to the virtual scene, and therefore the second virtual object controlled by the second account is displayed in the virtual scene. Therefore, the second change failure information is displayed in response to the object change instruction when the second virtual object controlled by the second account exists in the virtual scene. The second change failure information herein may alternatively be text information, for example, “a player of an object XX has logged into the game and change fails”.

In an actual application, when a virtual object controlled by an account exists in a virtual scene, changing to the corresponding virtual object is prohibited. In this way, balance of the game is ensured and interaction conflict between two same virtual objects is avoided.

In actual implementation, a process of receiving the object change instruction may be implemented by using an object presentation control. For example, the object presentation control is displayed; an object presentation interface including at least two changeable virtual objects is displayed in response to a triggering operation on the object presentation control; where the at least two changeable virtual objects include the second virtual object; and the object change instruction is received in response to a selection operation on the second virtual object of the at least two changeable virtual objects.

The object presentation control may be displayed on a corresponding virtual interface of the virtual scene when the virtual scene is displayed, or may be displayed on a display interface of a camp to which the corresponding virtual object belongs. For example, as described above, the virtual scene includes a plurality of camps, each camp includes at least one virtual object, and virtual objects in different camps are in a confrontational relationship, that is, an enemy relationship. Therefore, the first virtual object and the second virtual object may belong to one camp, that is, a target camp. In this case, a camp display control is displayed in the virtual scene, and a display interface of the target camp is displayed in response to a triggering operation on the camp display control. Then, the object presentation control and introduction information of the target camp are displayed on the display interface of the target camp, where the introduction information of the target camp includes at least one of the following: a name of the target camp, an establishment time of the target camp, at least one virtual object included in the target camp, a creator of the target camp, and the like.

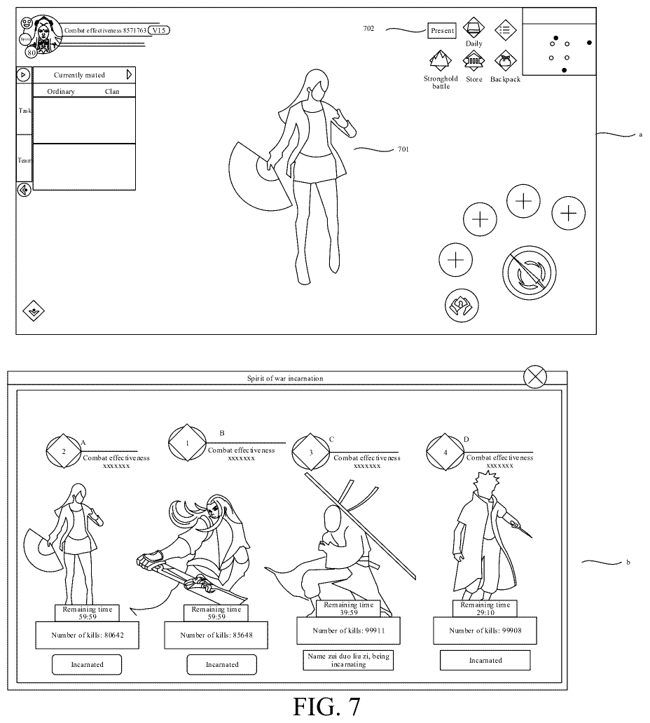

FIG. 6 is a schematic diagram of display of an object presentation interface according to an aspect of this disclosure, and FIG. 7 is a schematic diagram of display of an object presentation interface according to an aspect of this disclosure. Based on FIG. 6, a camp display control is displayed in the virtual scene, so that a display interface of a target camp indicated by a in FIG. 6 is displayed in response to a triggering operation on the camp display control. Then, an object presentation control indicated by 601 and introduction information of the target camp are displayed on the display interface of the target camp. Then, an object presentation interface including at least two changeable virtual objects and indicated by b in FIG. 6 is displayed in response to a triggering operation on the object presentation control. Finally, the object change instruction is received in response to a selection operation on the second virtual object indicated by D in b.

Alternatively, based on FIG. 7, a first virtual object indicated by 701 in a and an object presentation control indicated by 702 in a are displayed in a virtual scene, and then an object presentation interface including at least two changeable virtual objects and indicated by b in FIG. 7 is displayed in response to a triggering operation on the object presentation control. Finally, the object change instruction is received in response to a selection operation on the second virtual object indicated by D in b.

By applying the foregoing aspect, the object presentation interface displays a plurality of changeable virtual objects for a user to select. In this way, changeable virtual objects are preset, thereby improving flexibility of an object change process of the virtual scene and human-computer interaction efficiency.

In some aspects, the object presentation interface may further display a number of defeats corresponding to each changeable virtual object; where the number of defeats is used to indicate a total number of virtual objects that are defeated when the corresponding changeable virtual object is controlled by different accounts to perform object interaction. Herein, the different accounts include a target account corresponding to a corresponding changeable virtual object and an account other than the target account.

For example, as shown in FIG. 6, when there are four changeable virtual objects A, B, C, and D, numbers of defeats 80642, 85648, 99911, and 99908 corresponding to the changeable virtual objects are respectively displayed. The changeable virtual object C is used as an example, and 99911 is used to indicate that a sum of a number of other virtual objects that are defeated when a target account corresponding to the changeable virtual object C controls the changeable virtual object C to fight against other virtual objects, and a number of other virtual objects that are defeated when at least one account other than the target account changes a virtual object of the at least one account to the changeable virtual object C and controls the changeable virtual object C to fight against other virtual objects is 99911 in the target time period. For example, the target account corresponding to the changeable virtual object C has not controlled the changeable virtual object C to defeat any virtual object, but within a week, three other accounts respectively change virtual objects of the three other accounts to the changeable virtual object C. After a first another account changes a virtual object of the first another account to the changeable virtual object C, when the first another account controls the changeable virtual object C to fight against other virtual objects, a number of defeated other virtual objects is 33300. After a second another account changes a virtual object of the second another account to the changeable virtual object C, when the second another account controls the changeable virtual object C to fight against other virtual objects, a number of defeated other virtual objects is 33306. After a third another account changes a virtual object of the third another account to the changeable virtual object C, when the third another account controls the changeable virtual object C to fight against other virtual objects, a number of defeated other virtual objects is 33305. In this case, a number of defeats corresponding to the virtual object C is 33300+33305+33306, that is, 99911.

In an actual application, by displaying a number of defeats corresponding to each changeable virtual object, it is convenient for a user to select a virtual object, thereby avoiding that changeable virtual objects are frequently replaced subsequently due to blind selection by the user, and improving effectiveness of a selection operation, human-computer interaction efficiency, and hardware resource utilization of an electronic device.

In some aspects, each changeable virtual object is associated with a change control, and the selection operation is a triggering operation on the change control associated with the changeable virtual object. Therefore, a process of receiving the object change instruction in response to a selection operation on the second virtual object of the at least two changeable virtual objects may be: receiving the object change instruction in response to a triggering operation on a change control associated with the second virtual object of the at least two changeable virtual objects.

For example, still referring to FIG. 6, a dashed-line box 602 in FIG. 6 indicates a change control associated with each changeable virtual object. The object change instruction is received in response to a triggering operation on a change control corresponding to the last changeable virtual object D.

In actual implementation, when each changeable virtual object is associated with a change control and the object change instruction is triggered by a triggering operation on the change control, after the receiving the object change instruction in response to a triggering operation on a change control associated with the second virtual object of the at least two changeable virtual objects, the change control associated with the second virtual object may be further switched to a change removing control, where the change removing control is configured to remove control of the first account over the second virtual object; and the second virtual object controlled by the first account is changed back to the first virtual object when receiving a triggering operation on the change removing control.

When the triggering operation on the change control is received, the change control associated with the second virtual object is switched to the change removing control only on an object presentation interface corresponding to a user performing the triggering operation, but display of the change control of the second virtual object is canceled on an object presentation interface of another user. At the same time, change prompt information is displayed in a display position corresponding to the change control of the second virtual object. The change prompt information may prompt an account other than the first account and the second account that the second virtual object is being controlled by the first account. Herein, the change prompt information may be text information, for example, “in XXX incarnation”.

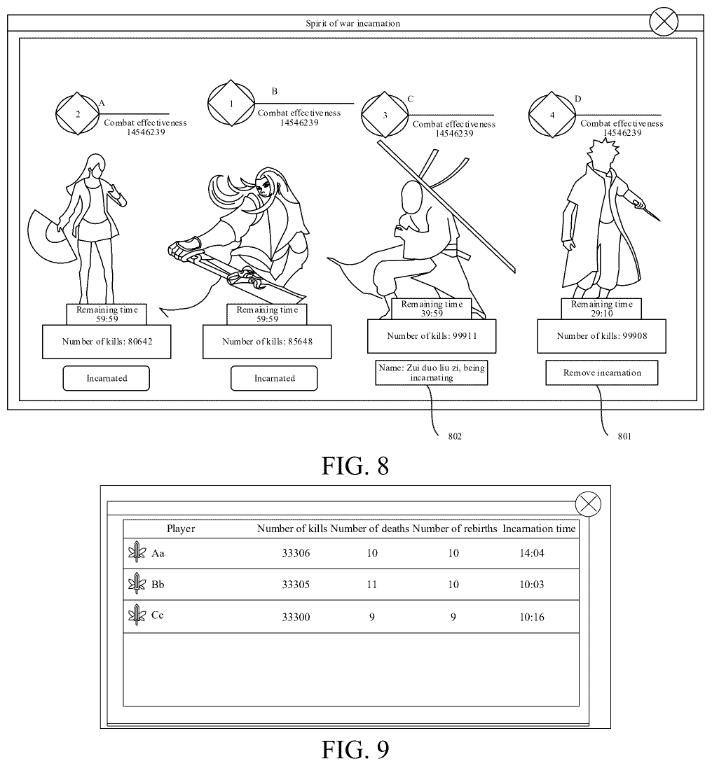

For example, still referring to FIG. 6, and referring to FIG. 8, FIG. 8 is a schematic diagram of a change removing control according to an aspect of this disclosure. Based on FIG. 6, in response to a triggering operation on the change control corresponding to the last changeable virtual object D, the change control corresponding to the changeable virtual object D is switched to a change removing control indicated by 801 in FIG. 8.

By applying the foregoing aspect, the change removing control removes control of an account over a virtual object. In this way, control of the account over the virtual object can be removed based on only one triggering operation, reducing difficulty in a process of removing control of the account over the virtual object, thereby improving human-computer interaction efficiency.

In actual implementation, when another changeable virtual object on the object presentation interface is being controlled by another account, change prompt information is further displayed in an associated position of the corresponding changeable virtual object, that is, a display position corresponding to a change control. The associated position of the changeable virtual object may be one of an upper position, a lower position, a left position, or a right position of the associated position. Correspondingly, the display position corresponding to the change control may also be one of an upper position, a lower position, a left position, or a right position of the display position. The change prompt information may prompt an account other than the target account controlling the changeable virtual object that the changeable virtual object is being controlled by the target account. For example, still referring to FIG. 8, the changeable virtual object C is being controlled by a player named Zui duo liu zi, and change prompt information indicated by 802 is displayed.

In some aspects, the first change time length corresponding to each changeable virtual object is further displayed on the object presentation interface. The first change time length herein is the first change time length described above. The first change time length herein may be displayed in a form of countdown. For example, when the target change time length is one hour, the first change time length corresponding to a changeable virtual object to which changing has not been performed is 59:59, but the first change time length corresponding to a changeable virtual object to which changing has been performed is a difference between one hour and an accumulated time length for changing to the corresponding changeable virtual object in the target time period. In this way, the displayed first change time length prompts a user of some changeable virtual objects that can still be selected for change, thereby improving change efficiency of a virtual object. For example, still referring to FIG. 6, the first change time length corresponding to each changeable virtual object indicated by a dashed-line box 603 is displayed on the object presentation interface, where changing to a changeable virtual object A and a changeable virtual object B has not been performed.

In some aspects, an interaction attribute corresponding to each changeable virtual object may be further displayed on the object presentation interface. The interaction attribute includes, but is not limited to, a level, a skill, and combat effectiveness of the virtual object, damage to another virtual object when interacting with the another virtual object, a defense value when interacting with another virtual object, and the like. In this way, the displayed interaction attribute makes it convenient for a user to determine to select a changeable virtual object for change, thereby improving change efficiency of the virtual object. For example, still referring to FIG. 6, combat effectiveness and a number of defeats of each changeable virtual object may be displayed on the object presentation interface.

In some aspects, each changeable virtual object is associated with an interaction detail control. Then, an interaction parameter detail interface of the second virtual object is displayed in response to a triggering operation on an interaction detail control corresponding to the second virtual object; and an interaction parameter generated when at least one other account controls the second virtual object to interact is displayed on the interaction parameter detail interface; where the another account is an account other than the second account in the virtual scene.

The at least one other account is one or more other accounts. The interaction detail control may be displayed in an associated position of a corresponding changeable virtual object, for example, in one of an upper position, a lower position, a left position, or a right position of the corresponding changeable virtual object. The interaction parameter includes at least one of the following: an identifier of each another account, and a number of defeats, a number of deaths, and a number of rebirths when a corresponding another account controls the second virtual object to interact, and a control time length in which the corresponding another account controls the second virtual object.

For example, still referring to FIG. 6 and FIG. 9, FIG. 9 is a schematic diagram of an interaction parameter detail interface according to an aspect of this disclosure. Based on FIG. 6, a dashed-line box 604 indicates an interaction detail control carrying a number of defeats. In this case, in response to a triggering operation on the interaction parameter detail control corresponding to the changeable virtual object C, an interaction parameter detail interface shown in FIG. 9 is displayed. Based on FIG. 9, interaction parameters generated when players Aa, Bb, and Cc control the changeable object C to interact are respectively displayed.

In an actual application, an interaction parameter of a corresponding changeable virtual object is displayed by using the interaction detail control, so that it is convenient for a user to select a virtual object, thereby avoiding that changeable virtual objects are frequently replaced subsequently due to blind selection by the user, and improving effectiveness of a selection operation, human-computer interaction efficiency, and hardware resource utilization of an electronic device.

In actual implementation, at least one other account is sorted on the interaction parameter detail interface based on interaction parameters such as numbers of defeats generated when other accounts control the second virtual object to interact, so that the interaction parameters generated when other accounts control the second virtual object to interact are displayed sequentially on the interaction parameter detail interface. When at least one other account cannot be displayed on the interaction parameter detail interface at the same time, the interaction parameters generated when other accounts control the second virtual object to interact may be sequentially displayed in response to a slide operation on the interaction parameter detail interface based on the numbers of defeats generated when other accounts control the second virtual object to interact.

Not any virtual object can be changed, and change permission is required. The change permission herein may be obtained when a level reaches a target level, or a time length of joining a corresponding camp reaches a target time length, or a position in a corresponding camp reaches a target position, or the like.

In actual implementation, before the object change instruction is received, a changeable virtual object further needs to be set. For example, before the changing the first virtual object controlled by the first account to the second virtual object in response to an object change instruction, an object setting control may be further displayed; an object setting interface including a plurality of candidate virtual objects is displayed in response to a triggering operation on the object setting control; and a target virtual object is determined, in response to a selection operation on the target virtual object of the plurality of candidate virtual objects, as a changeable virtual object for changing between different accounts; where the target virtual object includes the second virtual object.

Setting a changeable virtual object requires setting permission. When a triggering operation on the object setting control is received, permission detection is performed on an execution object of the triggering operation. When a detection result indicates that the execution object has setting permission for setting a changeable virtual object, the object setting interface including a plurality of candidate virtual objects is displayed in response to the triggering operation on the object setting control. When the detection result indicates that the execution object does not have the setting permission for setting a changeable virtual object, first permission insufficiency prompt information is displayed in response to the triggering operation on the object setting control. The first permission insufficiency prompt information is used to prompt that there is no setting permission for setting a changeable virtual object and a changeable virtual object cannot be set.

As described above, the virtual scene includes a plurality of camps, each camp includes at least one virtual object, and virtual objects in different camps are in a confrontational relationship, that is, an enemy relationship. Therefore, the plurality of candidate virtual objects are virtual objects in the same target camp, that is, all virtual objects in the target camp. Therefore, determining the target virtual object as a changeable virtual object for changing between different accounts refers to determining the target virtual object as a changeable virtual object to which a virtual object with a change permission in the target camp is changed. Herein, the plurality of candidate virtual objects may be sequentially displayed on the object setting interface based on interaction attributes such as combat effectiveness of the candidate virtual objects.

In actual implementation, the changeable object may be periodically set, and within one period, changeable virtual objects that are selectable by all virtual objects with a change permission in the target camp are the same.

Similar to the object presentation control, the object setting control may be displayed, when the virtual scene is displayed, on a virtual interface corresponding to the virtual scene. Alternatively, the object setting control may be displayed on a display interface of a camp to which a corresponding virtual object belongs, or may be displayed on an object presentation interface. This is not limited in this aspect of this disclosure. Herein, when the object setting control is displayed on the object presentation interface, the object setting control and the object presentation control are two interface switching controls, that is, the object presentation control is also displayed on the object setting interface.

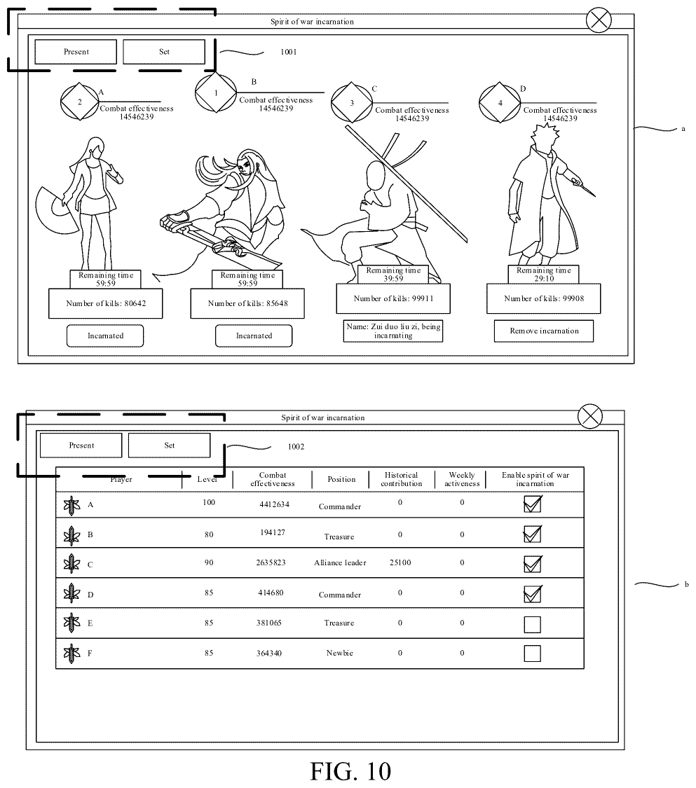

FIG. 10 is a schematic diagram of an object presentation interface and an object setting interface according to an aspect of this disclosure. Based on FIG. 10, the object setting control and the object presentation control are two interface switching controls. That is, as shown by a dashed-line box 1001 in a, the object setting control is displayed on an object presentation interface indicated by a, and as shown by a dashed-line box 1002 in b, the object presentation control is displayed on an object setting interface indicated by b. Then, in response to a selection operation on the target virtual objects A, B, C, and D in b, the target virtual objects A, B, C, and D are determined as changeable virtual objects for changing between different accounts.

By applying the foregoing aspect, the changeable virtual object for setting is displayed by using the object setting control, thereby improving convenience for a user to set the changeable virtual object and improving human-computer interaction efficiency.

In some aspects, there are at least two target virtual objects. When selection operations on a plurality of target virtual objects are sequentially received, error prompt information may be displayed in response to selection operations on current target virtual objects when a number of selected target virtual objects reaches a number threshold. The error prompt information is used to indicate that selection of the target virtual objects fails and the number of the target virtual objects has reached a maximum number.

The number threshold may be preset. To maintain interaction balance in the virtual scene, only a target number of changeable virtual objects can be set for one camp. After the target number of changeable virtual objects are selected, when selection operations on the target virtual objects are performed again, error prompt information, such as “cancel other changeable virtual objects to perform setting” is displayed. For example, as shown in FIG. 10, when the number threshold is 4, after the target virtual objects A, B, C, and D are selected, error prompt information is displayed when selection operations on the target virtual objects are performed again.

In actual implementation, when selection operations on target virtual objects are received, a number of selected target virtual objects is obtained, the number is compared with a number threshold, and when a comparison result indicates that the number of currently selected target virtual objects reaches the number threshold, it is determined that the target virtual objects corresponding to the selection operations cannot be used as changeable virtual objects, and then the error prompt information is displayed. When the comparison result indicates that the number of the currently selected target virtual objects does not reach the number threshold, the target virtual objects corresponding to the selection operations are used as changeable virtual objects.

In an actual application, by limiting a number of changeable virtual objects that can be set in one camp, interaction balance in the virtual scene is maintained and resource utilization is improved.

In some aspects, after a target virtual object is determined, in response to a selection operation on the target virtual object of the plurality of candidate virtual objects, as a changeable virtual object for changing between different accounts, a second change time length of each target virtual object may further be displayed. The second change time length is used to indicate an accumulated time length for changing to a corresponding target virtual object in the target time period. Cancellation failure information is displayed in response to a selection cancellation operation on the target virtual object whose second change time length is greater than a change time length threshold. The cancellation failure information is used to indicate that changing to the corresponding target virtual object cannot be performed in the target time period.

The change time length threshold may be preset, for example, may be zero. The second change time length being greater than zero is used to indicate that a corresponding target virtual object has been changed, and therefore cannot be changed in the target time period. Herein, the target time period may be preset, for example, may be one day. When the second change time length is displayed in a form of countdown, displaying cancellation failure information in response to a selection cancellation operation on a target virtual object whose second change time length is greater than a change time length threshold may be: displaying the cancellation failure information in response to a selection cancellation operation on a target virtual object whose second change time length is less than the target change time length. The target change time length is the same as the target change time length corresponding to the first change time length, and both are used to indicate a maximum accumulated time length for changing to a corresponding changeable virtual object in the target time period.

By applying the foregoing aspect, when the target virtual object is changed, the target virtual object cannot be changed in the target time period. This avoids that the changeable virtual object is frequently changed, thereby further ensuring balance of the game.

In the target time period, if a virtual object that is set as a changeable virtual object exits a corresponding camp and a number of changeable virtual objects reaches a target number before the exit, a new changeable object cannot be set in the target time period. When a selection operation on the target virtual object is received on the object setting interface, error prompt information is also displayed, and the error prompt information herein is used to indicate that selection of the target virtual object fails and a new changeable virtual object cannot be set in the target time period. In addition, a selected changeable virtual object also needs to have setting permission, for example, a time length in which a corresponding changeable virtual object joins a corresponding camp reaches a target time length, or a level of a corresponding changeable virtual object reaches a target level.

In some aspects, after the first virtual object controlled by the first account is changed to the second virtual object in response to the object change instruction, the second virtual object controlled by the first account may further be changed back to the first virtual object when a change removing condition of the second virtual object is satisfied, and a change waiting time length of the second virtual object is displayed. The change waiting time length is used to indicate a time length from a moment at which the first account releases control over the second virtual object to a current moment; and waiting prompt information may be displayed in response to the object change instruction for the second virtual object when the change waiting time length is less than a target change waiting time length; where the waiting prompt information is used to prompt that the first virtual object can be changed to the second virtual object when object change fails and the change waiting time length reaches the target change waiting time length.

As described above, the change removing condition herein may be: when change countdown ends, when the first change time length reaches the target change time length, when recovery countdown ends, when the detection result indicates that the first virtual space does not satisfy the object change condition of the first virtual object, when the second virtual object moves from the first virtual space to the second virtual space and the second virtual space does not satisfy the object change condition of the first virtual object, or the like.

In an actual application, when change of a virtual object is removed, the virtual object needs to wait for a target change waiting time length before being changed again. This avoids that an interaction process is imbalanced due to frequent change of the same virtual object, thereby improving the possibility of another virtual object is changed, and improving human-computer interaction efficiency and hardware resource utilization of an electronic device.

In actual implementation, when the change removing condition of the second virtual object is satisfied, after the second virtual object controlled by the first account is changed back to the first virtual object, a displayed change waiting time length of the second virtual object may be a cooling time length. The target change waiting herein may be, for example, ten minutes, so that changing to the second virtual object cannot be performed within ten minutes after the second virtual object controlled by the first account is changed back to the first virtual object, that is, waiting prompt information is displayed. The first virtual object can be changed to the second virtual object only when the change waiting time length reaches ten minutes, that is, when the cooling is completed.

In some aspects, the virtual scene includes at least two virtual organizations, and each virtual organization includes at least one virtual object. In this case, after the second virtual object is controlled, in response to an interaction instruction for the second virtual object controlled by the first account, to interact with another virtual object, the at least two virtual organizations may be combined in response to a combination instruction for the at least two virtual organizations, to obtain the target virtual organization. An object selection operation on the target virtual organization is received, where the object selection operation is used to instruct to select, from virtual objects included in the target virtual organization, a changeable virtual object for changing between different accounts; and selection error information is displayed in response to the object selection operation when a combination time length of the at least two virtual organizations corresponding to the target virtual organization does not reach a target combination time length; where the selection error information is used to indicate that a changeable virtual object cannot be selected from a plurality of virtual objects included in the target virtual organization.

The virtual organization herein is a camp. When two camps are combined, a changeable virtual object cannot be set within a target combination time length, for example, within one day. When an object selection operation instructing to select, from virtual objects included in the target virtual organization, a changeable virtual object for changing between different accounts is received, in response to the object selection operation, a combination time length of at least two virtual organizations corresponding to the target virtual organization is detected. When a detection result indicates that the combination time length of the at least two virtual organizations corresponding to the target virtual organization does not reach the target combination time length, selection error information is displayed, for example, “a changeable virtual object cannot be set today due to combination”. When the detection result indicates that the combination time length of the at least two virtual organizations corresponding to the target virtual organization reaches the target combination time length, a virtual object corresponding to the object selection operation is determined as a changeable virtual object for changing between different accounts.

By applying the foregoing aspect, after a plurality of camps are combined, it is restricted that a changeable object can be selected only after the target combination time length and a changeable virtual object cannot be selected within the target combination time length. In this way, interaction balance in the virtual scene is maintained, and resource utilization is improved.

In some aspects, after the controlling, in response to an interaction instruction for the second virtual object controlled by the first account, the second virtual object to interact with another virtual object, prompt information may be further sent to the second account. The prompt information includes at least one of the following: an identifier of the first account, and a number of defeats, a number of deaths, and a number of rebirths when the first account controls the second virtual object to interact, and a control time length in which the first account controls the second virtual object.

The prompt information herein may be in a form of an email, a form of an SMS message, or the like. This is not limited in this aspect of this disclosure. In addition, after changing to the second virtual object is performed, the prompt information is further sent to the second account, so that when a player of the second account logs into the client, the player can learn of virtual objects that control the second virtual object to interact, an interaction parameter in an interaction process, and the like. Herein, when a plurality of virtual objects control the second virtual object, the same number of pieces of prompt information is sent to the second account based on a number of the virtual objects. In this way, the prompt information is sent to the second account, to give a feedback to the second account in time, thereby improving communication timeliness and communication efficiency.

In some aspects, after the first virtual object controlled by the first account is changed to the second virtual object in response to the object change instruction, an identifier of the first virtual object, such as an avatar identifier and a name identifier, may further be displayed in an associated position in the virtual scene. Then, in response to a triggering operation on the identifier of the first virtual object, object information of the first virtual object is displayed. The object information includes interaction attribute information, backpack information, achievement information, costume information, and form information of the first virtual object. However, the associated position in the virtual scene may be any position in the virtual scene. This is not limited in the aspects of this disclosure.

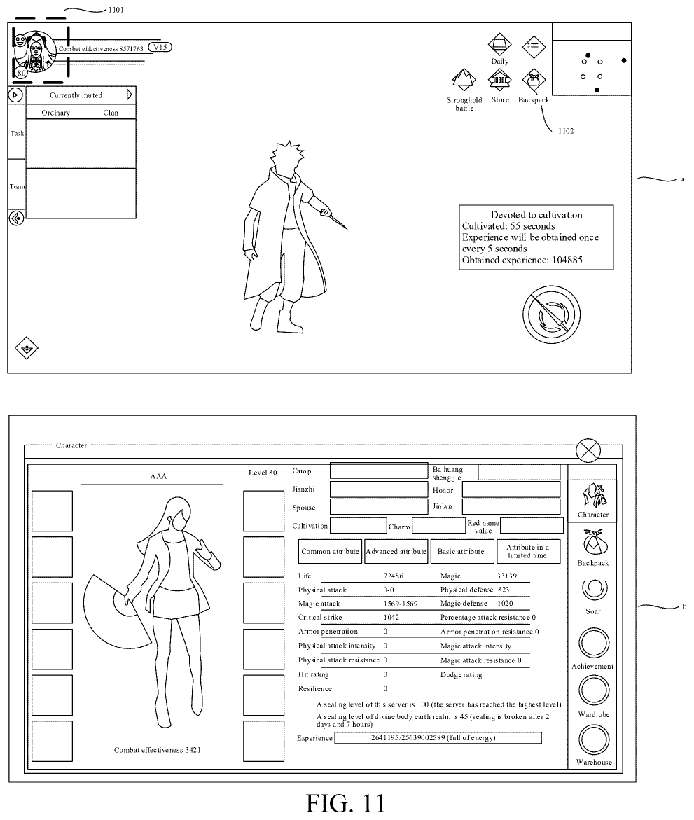

FIG. 11 is a schematic diagram of object information of a first virtual object according to an aspect of this disclosure. Based on FIG. 11, in response to a triggering operation on an avatar identifier of the first virtual object indicated by a dashed-line box 1101 in a, object information of the first virtual object in b is displayed.

In some aspects, after the first virtual object controlled by the first account is changed to the second virtual object in response to the object change instruction, a backpack control may further be displayed in an associated position in the virtual scene. A virtual backpack of the first virtual object is displayed in response to a triggering operation on the backpack control.

Although the first account controls the second virtual object, a virtual backpack of the first virtual object is displayed in response to a click operation on the backpack control, instead of a virtual backpack of the second virtual object. In this way, data security in a change process is improved.

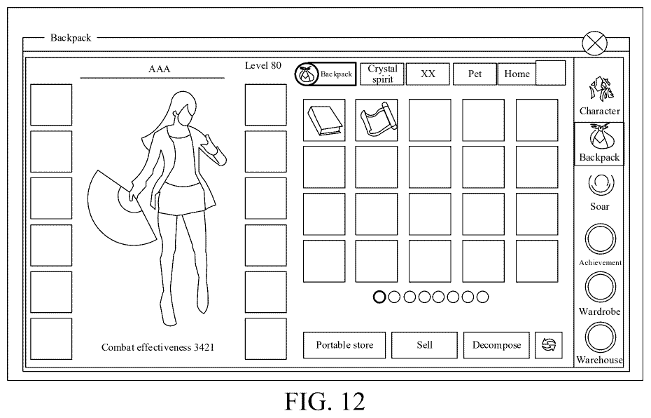

FIG. 12 is a schematic diagram of a virtual backpack of a first virtual object according to an aspect of this disclosure. Based on FIG. 11 and FIG. 12, in response to a triggering operation on the backpack control indicated by 1102 in a of FIG. 11, the virtual backpack of the first virtual object as shown in FIG. 12 is displayed.

In some aspects, after the first virtual object controlled by the first account is changed to the second virtual object in response to the object change instruction, a menu display entry may further be displayed in an associated position in the virtual scene. A menu that corresponds to the first virtual object and that includes at least one operation control is displayed in response to a triggering operation on the menu display entry. The operation control is configured to instruct to perform an interaction operation corresponding to the first virtual object, and interaction operations indicated by different operation controls are different. In response to a triggering operation on a target operation control of the at least one operation control, a target interaction operation that corresponds to the first virtual object and that is indicated by the target operation control is performed.

The operation control herein includes a skill control, an equipment control, a character control, a camp display control, and the like. Therefore, the process of performing, in response to the triggering operation on the target operation control of the at least one operation control, the target interaction operation that corresponds to the first virtual object and that is indicated by the target operation control may be: displaying the object information of the first virtual object in response to a triggering operation on the character control. The object information includes interaction attribute information, backpack information, achievement information, costume information, and form information of the first virtual object. Alternatively, at least one skill corresponding to the first virtual object is displayed in response to a triggering operation on the skill control. Alternatively, a display interface of a target camp to which the first virtual object belongs is displayed in response to a triggering operation on the camp display control. The at least one skill may be one or more skills.

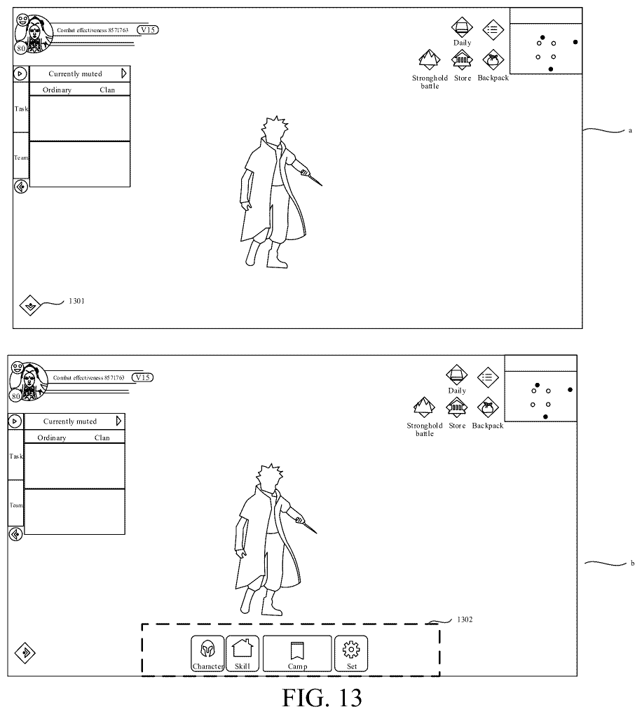

FIG. 13 is a schematic diagram of display of a menu that corresponds to a first virtual object and includes at least one operation control according to an aspect of this disclosure. Based on FIG. 13, in response to a triggering operation on a menu display entry indicated by 1301 in a, a menu that corresponds to the first virtual object and includes at least one operation control and that is indicated by a dashed-line box 1302 in b is displayed. Therefore, in response to a triggering operation on a target operation control of the at least one operation control, a target interaction operation that corresponds to the first virtual object and that is indicated by the target operation control is performed.

In some aspects, when another user clicks on a virtual object displayed in the virtual scene after change, a virtual object corresponding to an account controlling the virtual object is displayed. Herein, a third account controls a third virtual object, and a fourth account controls a fourth virtual object. In this case, when the fourth virtual object controlled by the third account is displayed in the virtual scene, at least one interaction control corresponding to the third virtual object is displayed in response to a triggering operation on the fourth virtual object. The interaction control is configured to instruct to perform an interaction operation corresponding to the third virtual object, and interaction operations indicated by different interaction controls are different. In response to a triggering operation on a target interaction control of the at least one interaction control, a target interaction operation that corresponds to the third virtual object and that is indicated by the target interaction control is performed.

The interaction control herein includes a chat control, an information check control, a friend adding control, a block control, and the like. Therefore, the process of performing, in response to the triggering operation on the target interaction control of the at least one interaction control, the target interaction operation that corresponds to the third virtual object and that is indicated by the target interaction control may be: displaying a chat window of the third virtual object in response to a triggering operation on the chat control, where the chat window is used to chat with the third virtual object. Alternatively, the object information of the third virtual object is displayed in response to a triggering operation on the information check control. The object information herein includes interaction attribute information, achievement information, costume information, form information, and the like of the third virtual object. Alternatively, the third virtual object is added as a friend in response to a triggering operation on the friend adding control. Alternatively, related information of the third virtual object is blocked in response to a triggering operation on the block control. The related information herein includes chat information sent by the third virtual object, and the like.

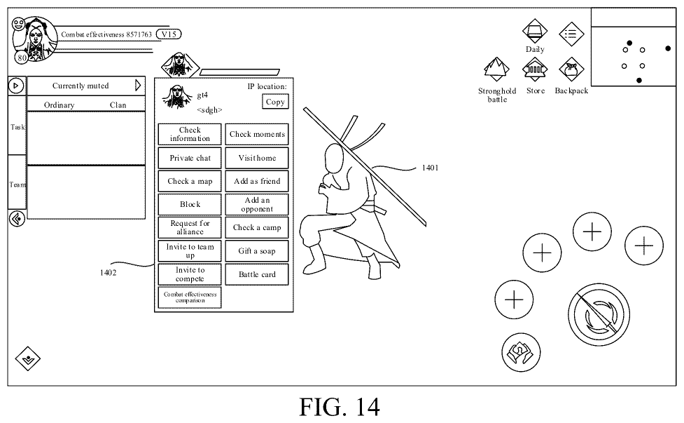

FIG. 14 is a schematic diagram of display of at least one interaction control corresponding to a third virtual object according to an aspect of this disclosure. Based on FIG. 14, a fourth virtual object indicated by 1401 is displayed in a virtual scene. The fourth virtual object herein is controlled by a third account, and at least one interaction control indicated by 1402 and corresponding to the third virtual object is displayed in response to a triggering operation on the fourth virtual object.

In this way, in a related-art solution, the second account needs to be logged into in a client to control the second virtual object to perform interaction. In this disclosure, the first virtual object corresponding to the first account is changed to the second virtual object, and the second virtual object is directly controlled by the first account to perform interaction. Therefore, secure data reuse is implemented, and a player is directly enabled to use an attribute of another player at a game attribute level, thereby avoiding potential risk of data tampering caused by logging into an account by a player and improving data security.

In some aspects, after the first virtual object controlled by the first account is displayed in the virtual scene, permission detection may further be performed on the first account, to obtain a permission detection result. Therefore, the process of changing, when a second virtual object controlled by a second account does not exist in the virtual scene, the first virtual object controlled by the first account to the second virtual object in response to an object change instruction may be: changing, when the second virtual object controlled by the second account does not exist in the virtual scene and the permission detection result indicates that the first account has object change permission, the first virtual object controlled by the first account to the second virtual object in response to the object change instruction.

As described above, not any virtual object can be changed. Similarly, not each account can change an original virtual object to another virtual object, and only when the corresponding account has the object change permission, the account can change the original virtual object to another virtual object. The object change permission herein may be obtained when a level of the account reaches a target level, or a time length in which the original virtual object controlled by the account joins a corresponding camp reaches a target time length, or a position of the original virtual object controlled by the account in a corresponding camp reaches a target position, or the like.

In actual implementation, second permission insufficiency prompt information is displayed when the permission detection result indicates that the first account does not have the object change permission; where the second permission insufficiency prompt information is used to indicate that the first account does not have the object change permission and the controlled first virtual object cannot be changed to the second virtual object.

Operation 103: Control, in response to an interaction instruction for the second virtual object controlled by the first account, the second virtual object to interact with another virtual object, the another virtual object being a virtual object other than the first virtual object and the second virtual object in the virtual scene. For example, based on an interaction instruction directed to the second virtual object controlled by the first account, the second virtual object is controlled to interact with a third virtual object in the virtual environment.

When the first account controls the second virtual object to interact with another virtual object, used skills, equipment, and interaction attributes all belong to the second virtual object, but obtained experience and virtual assets belong to the first virtual object. In addition, the first account cannot use, in an interaction process, skills and equipment corresponding to the first virtual object, but can obtain an item with added value such as a virtual medicine from a virtual backpack of the first virtual object for usage.

In actual implementation, when the first virtual object is changed to the second virtual object, only an interaction attribute of the second virtual object when the second account exits the game in a case that the second virtual object is controlled by the second account mostly recently is obtained, and an interaction attribute when change is removed after a previous virtual object is changed to the second virtual object is not obtained.

By applying the above aspect of this disclosure, when the second virtual object controlled by the second account does not exist in the virtual scene, the first virtual object controlled by the first account is changed to the second virtual object, so that the first account controls the second virtual object to interact with another virtual object. In this way, the first virtual object controlled by the first account is changed to the second virtual object, and the first account replaces the second account to control the second virtual object to interact with another virtual object, thereby not only enriching an interaction process of players and improving diversity of interaction manners in the virtual scene and resource utilization in the virtual scene, but also improving human-computer interaction efficiency and hardware resource utilization of an electronic device.

An application of the aspects of this disclosure in an actual application scenario will be described below.

In a related massive multiplayer online role-playing game (MMORPG), players spending much money have high combat effectiveness, and players with high combat effectiveness have many advantages in participating in many activities in the game. Consequently, players with high combat effectiveness consume more time and energy to participate in activities, causing a heavy burden. However, these players spending much money are usually busy, and do not have much time for games. In this way, game experience of players spending much money and players spending less money is greatly different. Consequently, it is very difficult to form a good social atmosphere, and a social gap easily occurs.

Based on this, an aspect of this disclosure provides a design solution of reducing the burden of players spending much money and promoting social interaction between players with different financial abilities. By means of this disclosure, players spending much money do not need to be frequently online, and some small-scale and disordered battles may be completed by a blood alliance manager after going online and incarnating. In this way, players with high combat effectiveness, that is, players spending much money, can focus energy on more important activities, and this reduces the burden of players with high combat effectiveness. In addition, after a blood alliance manager incarnates, the blood alliance manager presents, to a blood alliance member, a status of using an incarnation, and feeds back a clearer online email for a player with high combat effectiveness, thereby better promoting the social atmosphere of the entire blood alliance, and adding a social link to players spending much money and players spending less money, to maintain the social environment.

The blood alliance (a camp and a virtual organization) is a multi-party social group, and the blood alliance may participate in activities, that is, perform interaction as a unit. The blood alliance manager is a player with special rights in the blood alliance, including deputy alliance leader, alliance leader, 2 commanders, and 2 treasures, that is, a total of 6 persons. The special rights include personnel invocation, activity initiation, and the like, and incarnating to spirit of war, spirit of war setting, and the like in this disclosure. The spirit of war is a player with high combat effectiveness set by the blood alliance manager, and the blood alliance manager may directly incarnate to a player with high combat effectiveness to participate in interaction. The combat effectiveness is used to evaluate the strength of a game character of a player, and higher combat effectiveness indicates higher strength.

The technical solution of this disclosure is described below from the product side.

In actual implementation, the blood alliance manager may set the spirit of war (a changeable virtual object) as a player with high combat effectiveness in the blood alliance, and incarnation of the spirit of war may be managed (changed), for a changing player (the first virtual object) to use attributes and various skills. An attribute of the player with high combat effectiveness (the second virtual object) is an attribute recorded when going offline the previous day. In addition, change has a time limit (the target change time length), and each player with high combat effectiveness can only use a change time of one hour each day. After change, a special change title (a change identifier) is used for distinguishing, and other appearance display is basically equivalent to that of a player with high combat effectiveness. After a player with high combat effectiveness goes online, the change is synchronously removed, and the player with high combat effectiveness receives an email feedback (prompt information). In addition, only a part of a map (a virtual space) supports the technical solution of this disclosure (satisfies the object change condition).

In actual implementation, as shown in FIG. 6, a “spirit of war button” (an object presentation control) is displayed on a blood alliance interface (a camp display interface), and a spirit of war interface (an object presentation interface) is displayed in response to a triggering operation on the button. Herein, as shown in FIG. 10, an interface switching control (an object setting control) is further displayed on the spirit of war interface, so as to jump to a setting interface (an object setting interface) from the spirit of war interface in response to a triggering operation on the interface switching control. Herein, only a server with a level 70 has permission to open the setting interface (setting permission), and at the same time, a number of spirits of war (the number threshold corresponding to the target virtual object) is preset.

After the server reaches the level 70, the server may set incarnation of spirit of war, change cannot be performed when a player with high combat effectiveness (the second virtual object) is online, and a number of defeats changes to a clickable control. In response to a click operation on the number of defeats, an interface shown in FIG. 9 is displayed. The interface displays a name of an incarnating player, a number of defeats, a number of deaths, a number of immediate rebirths, and an incarnation time. The interface supports sliding down, and changing players on the interface are sorted according to numbers of defeats. The number of defeats is a sum of a number of defeats of a current player+a number of defeats during incarnation. Then, as shown in FIG. 6 and FIG. 8, in response to a click operation on an incarnation button, the incarnation button is changed to a name of a character using the change (an incarnation removing button is displayed for a changing player, and a name of the changing player is displayed for other players). Meanwhile, after any player removes the incarnation for any reason, a 10-minute cooling time (the target change waiting time length) is added, and during this period, no one can use the incarnation. In addition, when the changing player (the first virtual object) goes offline or switches to a map that cannot support change, change is automatically removed, and a changing time (the first change time length) synchronously stops.

In actual implementation, the setting interface is equivalent to a list of blood alliance members (candidate virtual objects), and members may be sorted based on combat effectiveness. A plurality of spirit of war incarnations (changeable objects) may be selected on the setting interface, and when the selected spirit of war incarnations exceed a number threshold, error information is prompted (error prompt information), for example, “cancel another spirit of war to perform setting again”.

If it is set in the target time period that a spirit of war incarnation exits the blood alliance and a number of spirit of war incarnations reaches a target number before the exit, a new changeable object cannot be set in the target time period. When a selection operation on a spirit of war incarnation is received on the setting interface, error prompt information is also displayed, and the error prompt information herein is used to indicate that a new spirit of war incarnation cannot be set in the target time period. In addition, a selected spirit of war incarnation also needs to have setting permission, for example, a time length in which a corresponding changeable virtual object joins a corresponding camp reaches a target time length.

In actual implementation, at least two blood alliances may be combined in response to a combination instruction for the at least two blood alliances, to obtain a target blood alliance. An object selection operation on the target blood alliance is received, where the object selection operation is used to instruct to select, from members included in the target blood alliance, a spirit of war incarnation for changing between different players. Selection error information is displayed in response to the object selection operation when a combination time length of the at least two blood alliances corresponding to the target blood alliance does not reach a target combination time length, for example, one day. The selection error information is used to indicate that the spirit of war incarnation cannot be selected from the plurality of members included in the target blood alliance.

In actual implementation, countdown (change countdown) and a change identifier such as “spirit” are added to an upper left corner of a changing player (the first virtual object), and a change identifier “spirit of war incarnation” is also displayed above the changing player.

Usage limitation includes level limitation, map limitation, time limitation, and position limitation. For the level limitation, for example, only a server reaching a level 70 can support the technical solution of this disclosure, and only a player reaching the level 70 can implement a function of this disclosure. In this way, a small operation entity is prevented from using the function. For the map limitation, for example, the function can be used only in a special map. For the time limitation, each change can only be used for one hour. If a click operation on the incarnation control needs to be performed again when the time ends, the time can be purchased with gold coins (virtual assets). For the position limitation, a target position or a position above may be changed. In addition, during login of a player with high combat effectiveness, removing countdown (recovery countdown) pops up on an interface of a changing player, and change is immediately removed after countdown ends.

After changing to a player with high combat effectiveness is performed, an email may be obtained when the player goes online, to prompt change to a player XX with high combat effectiveness, defeat of XX players, a number of deaths, a number of immediate rebirths, and the like.

In actual implementation, a skill, equipment, and an interaction attribute used by a changing player all belong to a player with high combat effectiveness, but obtained experience belongs to the changing player. In addition, a changing player cannot use, in an interaction process, a corresponding skill and equipment of the changing player, but can obtain an item with added value such as a virtual medicine from a virtual backpack of the changing player for usage.

In actual implementation, as shown in FIG. 14, when a click operation of another player on a player with high combat effectiveness to which a changing player incarnates is received, information about the changing player is displayed.

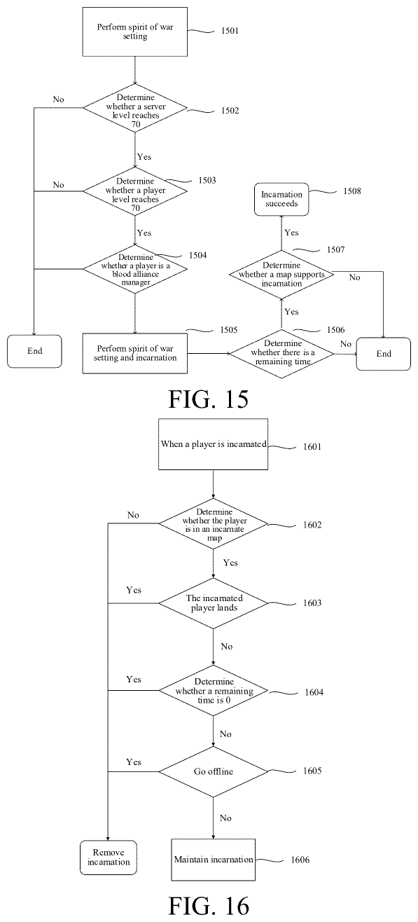

The technical solution of this disclosure is described below from the technical side. FIG. 15 is a schematic flowchart in which a changing player performs incarnation according to an aspect of this disclosure. Based on FIG. 15, a change process of a changing player can be implemented through operation 1501 to operation 1508. For example, whether the server reaches the level 70 is determined. Only after the server reaches the level 70, the function is enabled, and after the server reaches the level 70, a blood alliance manager may set a spirit of war. Then, in response to a triggering operation on the incarnation control, whether a level of a blood alliance manager performing the click operation reaches the level 70 is determined, and only a blood alliance manager that reaches the level can perform incarnation. Then, whether the spirit of war incarnation still has a remaining time is determined, and only a spirit of war with a remaining time can be incarnated. Then, whether the spirit of war is in a cooling time is determined, and the spirit of war in the cooling time cannot be incarnated. Finally, whether the incarnation is in a map that can support incarnation is determined, and incarnation can be performed only in the map. When all of the foregoing determining conditions are satisfied, the incarnation may succeed.

FIG. 16 is a schematic flowchart in which a changing player removes incarnation according to an aspect of this disclosure. Based on FIG. 16, an incarnation removing process of a changing player can be implemented through operation 1601 to operation 1606. For example, When a successfully incarnating changing player goes to another map, it needs to be determined whether the destination map is a map supporting incarnation, and if not, incarnation is removed immediately. When a corresponding player with high combat effectiveness logs into a game, removing countdown pops up on an interface of a changing player, and the change is immediately removed after the countdown ends. The incarnation is automatically removed when the changing player is offline, thereby avoiding a waste of time. When the remaining time corresponding to the spirit of war incarnation is 0, that is, the time length for changing to the spirit of war incarnation reaches the maximum accumulated time length, the incarnation is canceled.

In this way, by means of this disclosure, secure data reuse is implemented while preventing a player from directly logging into an account of another player, and a player is directly enabled to use an attribute of a player with high combat effectiveness at a game attribute level, thereby avoiding potential risk of data tampering caused by logging into an account by a player. In addition, a player with low combat effectiveness may experience an attribute of a player with high combat effectiveness. This can greatly promote social interaction between a player with high combat effectiveness and a player with low combat effectiveness and enrich game experience.

In application of the above aspect of this disclosure, when the second virtual object controlled by the second account does not exist in the virtual scene, the first virtual object controlled by the first account is changed to the second virtual object, so that the first account controls the second virtual object to interact with another virtual object. In this way, the first virtual object controlled by the first account is changed to the second virtual object, and the first account replaces the second account to control the second virtual object to interact with another virtual object, thereby not only enriching an interaction process of players and improving diversity of interaction manners in the virtual scene and resource utilization in the virtual scene, but also improving human-computer interaction efficiency and hardware resource utilization of an electronic device.

The following proceeds to describe an example structure of the interaction apparatus 455 for a virtual scene implemented as a software module in the aspects of this disclosure. In some aspects, as shown in FIG. 2, the software module in the interaction apparatus 455 for a virtual scene stored in the memory 450 may include:
a display module 4551, configured to display, in a virtual scene, a first virtual object controlled by a first account;
a change module 4552, configured to change, when a second virtual object controlled by a second account does not exist in the virtual scene, the first virtual object controlled by the first account to the second virtual object in response to an object change instruction; and
a control module 4553, configured to control, in response to an interaction instruction for the second virtual object controlled by the first account, the second virtual object to interact with another virtual object, the another virtual object being a virtual object other than the first virtual object and the second virtual object in the virtual scene.

In some aspects, the apparatus further includes a second display module. The second display module is configured to display change countdown, where the change countdown is used to indicate a time length in which the first account can control the second virtual object; and change the second virtual object controlled by the first account back to the first virtual object when the change countdown ends.

In some aspects, the apparatus further includes a third display module. The third display module is configured to display a first change time length, where the first change time length is used to indicate an accumulated time length for changing to the second virtual object in a target time period; and the change module 4552 is further configured to change the first virtual object controlled by the first account to the second virtual object in response to the object change instruction when the first change time length is less than a target change time length.

In some aspects, the apparatus further includes a fourth display module. The fourth display module is configured to display first change failure information in response to the object change instruction when the first change time length reaches the target change time length; where the first change failure information is used to indicate that the accumulated time length for changing to the second virtual object in the target time period has reached a maximum accumulated time length.

In some aspects, the apparatus further includes a fifth display module. The fifth display module is configured to display, in the virtual scene, the second virtual object controlled by the first account, and display a change identifier in an associated position of the second virtual object controlled by the first account; where the change identifier is used to prompt that the second virtual object is not controlled by the second account.

In some aspects, the apparatus further includes a sixth display module. The sixth display module is configured to display recovery countdown when a status of the second account switches from a not-logged-in status to a logged-in status, where the recovery countdown is used to indicate a time length still required to change the second virtual object back to the first virtual object; and change the second virtual object controlled by the first account back to the first virtual object when the recovery countdown ends.

In some aspects, the virtual scene includes a first virtual space, and the display module 4551 is further configured to display, in the first virtual space of the virtual scene, the first virtual object controlled by the first account; and the change module 4552 is further configured to detect the first virtual space in response to the object change instruction; and change the first virtual object controlled by the first account to the second virtual object when a detection result indicates that the first virtual space satisfies an object change condition of the first virtual object.

In some aspects, the virtual scene further includes a second virtual space, and the apparatus further includes a second control module. The second control module is configured to control, in response to a movement operation on the second virtual object, the second virtual object to move in the first virtual space; and change the second virtual object controlled by the first account back to the first virtual object when the second virtual object moves from the first virtual space to the second virtual space and the second virtual space does not satisfy the object change condition of the first virtual object.

In some aspects, the apparatus further includes a seventh display module. The seventh display module is configured to display second change failure information in response to the object change instruction when the second virtual object controlled by the second account exists in the virtual scene; where the second change failure information is used to indicate that object change fails and the second virtual object controlled by the second account exists in the virtual scene.

In some aspects, the apparatus further includes an eighth display module. The eighth display module is configured to display an object presentation control; and display, in response to a triggering operation on the object presentation control, an object presentation interface including at least two changeable virtual objects; where the at least two changeable virtual objects include the second virtual object; and receive the object change instruction in response to a selection operation on the second virtual object of the at least two changeable virtual objects.

In some aspects, the apparatus further includes a ninth display module. The ninth display module is configured to display, in the object presentation interface, a number of defeats corresponding to each changeable virtual object; where the number of defeats is used to indicate a total number of virtual objects that are defeated when the changeable virtual object is controlled by different accounts to perform object interaction.

In some aspects, each changeable virtual object is associated with an interaction detail control, and the apparatus further includes a tenth display module. The tenth display module is configured to display an interaction parameter detail interface of the second virtual object in response to a triggering operation on an interaction detail control corresponding to the second virtual object; and display, on the interaction parameter detail interface, an interaction parameter generated when at least one other account controls the second virtual object to interact; where the another account is an account other than the second account in the virtual scene.

In some aspects, each changeable virtual object is associated with a change control, the object change instruction is triggered by a triggering operation on the change control, and the apparatus further includes a switching module. The switching module is configured to switch the change control associated with the second virtual object to a change removing control; where the change removing control is configured to release control of the first account over the second virtual object; and change the second virtual object controlled by the first account back to the first virtual object when receiving a triggering operation on the change removing control.

In some aspects, the apparatus further includes an eleventh display module, and the eleventh display module is configured to display an object setting control; and display, in response to a triggering operation on the object setting control, an object setting interface including a plurality of candidate virtual objects; and determine, in response to a selection operation on a target virtual object of the plurality of candidate virtual objects, the target virtual object as a changeable virtual object for changing between different accounts; where the target virtual object includes the second virtual object.

In some aspects, there is a plurality of target virtual objects, and when selection operations for a plurality of target virtual objects are sequentially received, the apparatus further includes a twelfth display module. The twelfth display module is configured to display, when a number of selected target virtual objects reaches a number threshold, error prompt information in response to selection operations on the current target virtual objects; where the error prompt information is used to indicate that selection of the target virtual objects fails and the number of the target virtual objects has reached a maximum number.

In some aspects, the apparatus further includes a thirteenth display module. The thirteenth display module is configured to display a second change time length of each target virtual object, where the second change time length is used to indicate an accumulated time length for changing to the corresponding target virtual object in a target time period; and display cancellation failure information in response to a selection cancellation operation on the target virtual object whose second change time length is greater than a change time length threshold; where the cancellation failure information is used to indicate that changing to the corresponding target virtual object cannot be performed in the target time period.

In some aspects, the apparatus further includes a fourteenth display module. The fourteenth display module is configured to change the second virtual object controlled by the first account back to the first virtual object when a change removing condition of the second virtual object is satisfied, and display a change waiting time length of the second virtual object; where the change waiting time length is used to indicate a time length from a moment at which the first account releases control over the second virtual object to a current moment; and display waiting prompt information in response to the object change instruction for the second virtual object when the change waiting time length is less than a target change waiting time length; where the waiting prompt information is used to prompt that the first virtual object can be changed to the second virtual object when object change fails and the change waiting time length reaches the target change waiting time length.

In some aspects, there are at least two virtual organizations in the virtual scene, and each virtual organization includes at least one virtual object; and the apparatus further includes a combination module, and the combination module is configured to combine the at least two virtual organizations in response to a combination instruction for the at least two virtual organizations, to obtain a target virtual organization; receive an object selection operation on the target virtual organization, where the object selection operation is used to instruct to select, from virtual objects included in the target virtual organization, a changeable virtual object for changing between different accounts; and display selection error information in response to the object selection operation when a combination time length of the at least two virtual organizations corresponding to the target virtual organization does not reach a target combination time length; where the selection error information is used to indicate that a changeable virtual object cannot be selected from a plurality of virtual objects included in the target virtual organization.

In some aspects, the apparatus further includes a sending module, and the sending module is configured to transmit prompt information to the second account; where the prompt information includes at least one of the following: an identifier of the first account, and a number of defeats, a number of deaths, and a number of rebirths when the first account controls the second virtual object to interact.

In some aspects, the apparatus further includes a permission detection module, and the permission detection module is configured to perform permission detection on the first account to obtain a permission detection result; and the change module 4552 is further configured to change, when the second virtual object controlled by the second account does not exist in the virtual scene and the permission detection result indicates that the first account has object change permission, the first virtual object controlled by the first account to the second virtual object in response to the object change instruction.

In some aspects, the apparatus further includes a fifteenth display module. The fifteenth display module is configured to display second permission insufficiency prompt information when the permission detection result indicates that the first account does not have the object change permission; where the second permission insufficiency prompt information is used to indicate that the first account does not have the object change permission and the controlled first virtual object cannot be changed to the second virtual object.

An aspect of this disclosure provides a computer program product or a computer program. The computer program product or the computer program includes computer instructions. The computer instructions are stored in a computer-readable storage medium. A processor of an electronic device reads the computer instructions from the computer-readable storage medium. The processor executes the computer instructions, so that the electronic device performs the interaction method for a virtual scene provided in the aspects of this disclosure.

An aspect of this disclosure provides a computer-readable storage medium such as a non-transitory computer-readable storage medium, having executable instructions stored therein, the executable instructions, when executed by a processor, causing the processor to perform the interaction method for a virtual scene provided in the aspects of this disclosure, for example, the interaction method for a virtual scene shown in FIG. 3.

In some aspects, the computer-readable storage medium may be a storage such as a read-only memory (ROM), a random access memory (RAM), an erasable programmable read-only memory (EPROM), an electrically erasable programmable read-only memory (EEPROM), a flash memory, a magnetic surface memory, an optical disc, or a CD-ROM, or may be various devices including one of or any combination of the foregoing memories.

In some aspects, the executable instructions may be in the form of programs, software, software modules, scripts, or code written in any form of programming language (including compiled or interpreted languages, or declarative or procedural languages), an can be deployed in any form, for example, deployed as a stand-alone program or as a module, component, subroutine, or other units suitable for usage in a computing environment.

For example, the executable instructions may, but do not necessarily, correspond to a file in a file system, and may be stored in a part of a file that saves another program or other data, for example, be stored in one or more scripts in a hypertext markup language (HTML) file, stored in a single file that is specially configured for a program in discussion, or stored in the plurality of collaborative files (for example, be stored in files of one or more modules, subprograms, or code parts).

For example, the executable instructions can be deployed to be executed on one electronic device, or on a plurality of electronic devices located at one site, or on a plurality of electronic devices distributed across a plurality of sites and interconnected by a communication network.

In conclusion, the aspects of this disclosure have the following beneficial effects:

(1) The first virtual object controlled by the first account is changed to the second virtual object, and the first account replaces the second account to control the second virtual object to interact with another virtual object, thereby not only enriching an interaction process of players and improving diversity of interaction manners in the virtual scene and resource utilization in the virtual scene, but also improving human-computer interaction efficiency and hardware resource utilization of an electronic device.

(2) In a related-art solution, the second account needs to be logged into in a client to control the second virtual object to perform interaction. In this disclosure, the first virtual object corresponding to the first account is changed to the second virtual object, and the second virtual object is directly controlled by the first account to perform interaction. Therefore, secure data reuse is implemented, and a player is directly enabled to use an attribute of another player at a game attribute level, thereby avoiding potential risk of data tampering caused by logging into an account by a player and improving data security.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing descriptions are only some examples of this disclosure and are not intended to limit the scope of this disclosure. Any modification, equivalent replacement, or improvement made without departing from the spirit and scope of this disclosure shall fall within the scope of this disclosure.

What is claimed is:

1. A method for interaction in a virtual environment, the method comprising:
outputting for display, in the virtual environment, a first virtual object controlled by a first account;
when a second virtual object controlled by a second account is not present in the virtual environment and an object transformation instruction is received, transforming, by processing circuitry, the first virtual object into the second virtual object based on the object transformation instruction; and
based on an interaction instruction directed to the second virtual object controlled by the first account, controlling the second virtual object to interact with a third virtual object in the virtual environment.

2. The method according to claim 1, further comprising:
outputting for display a transformation countdown indicating a remaining duration during which the first account is permitted to control the second virtual object; and
when the transformation countdown expires, transforming the second virtual object back into the first virtual object.

3. The method according to claim 1, further comprising:
outputting for display a first transformation duration indicating a cumulative duration that the second virtual object has been transformed within a target period; and
transforming the first virtual object into the second virtual object when the first transformation duration is less than a target transformation duration.

4. The method according to claim 3, further comprising:
based on the first transformation duration being greater than or equal to the target transformation duration, outputting for display a transformation failure message indicating that the second virtual object cannot be transformed during the target period.

5. The method according to claim 1, further comprising:
outputting for display a transformation indicator at an associated position of the second virtual object, the transformation indicator indicating that the second virtual object is not controlled by the second account.

6. The method according to claim 1, further comprising:
when the second account changes from a logged-out state to a logged-in state, outputting for display a restoration countdown indicating a remaining duration until the second virtual object is transformed back into the first virtual object; and
when the restoration countdown expires, transforming the second virtual object back into the first virtual object.

7. The method according to claim 1, wherein the virtual environment includes a first virtual space, and the outputting for display the first virtual object comprises:
outputting for display the first virtual object in the first virtual space of the virtual environment; and
the transforming the first virtual object into the second virtual object comprises:
transforming the first virtual object when the first virtual space satisfies a transformation condition.

8. The method according to claim 7, further comprising:
controlling movement of the second virtual object within the first virtual space; and
when the second virtual object moves into a second virtual space that does not satisfy the transformation condition, transforming the second virtual object back into the first virtual object.

9. The method according to claim 1, further comprising:
when the second virtual object controlled by the second account is present in the virtual environment, outputting for display a transformation failure message indicating that the transformation is not permitted.

10. The method according to claim 1, further comprising:
outputting for displaying an object display control element;
based on a trigger operation performed on the object display control element, outputting for display user interface including at least two transformable virtual objects, the at least two transformable virtual objects including the second virtual object; and
receiving the object transformation instruction based on a selection operation performed on the second virtual object from the at least two transformable virtual objects in the user interface.

11. The method according to claim 10, further comprising:
outputting for display, in the user interface, a defeat count associated with each of the at least two transformable virtual objects, the defeat count indicating a number of virtual objects defeated by the respective transformable virtual object.

12. The method according to claim 10, further comprising:
outputting for display, in the user interface, interaction statistics associated with at least one of the transformable virtual objects, the interaction statistics being associated with actions performed by the second virtual object while the second virtual object is not controlled by the second account.

13. The method according to claim 10, wherein each of the transformable virtual objects displayed in the user interface is associated with a transformation control element, and the method comprises:
receiving a trigger operation on the transformation control element associated with the second virtual object; and
after transforming the first virtual object into the second virtual object, the transformation control element associated with the second virtual object is replaced with a transformation release control element, and triggering the transformation release control element transforms the second virtual object back into the first virtual object.

14. The method according to claim 1, further comprising:
outputting for display an object setting control element;
based on a trigger operation performed on the object setting control element, outputting for display a setting interface including a plurality of candidate virtual objects that are available for designation as transformable virtual objects; and
based on a selection operation performed on a target virtual object from the plurality of candidate virtual objects, designating the target virtual object as a transformable virtual object, the target virtual object including the second virtual object.

15. The method according to claim 14, further comprising:
when a number of transformable virtual objects designated in the virtual environment reaches a threshold, outputting for display an error message based on an attempt to designate an additional candidate virtual object as a transformable virtual object, the error message indicating that a maximum number of transformable virtual objects is reached.

16. The method according to claim 1, wherein the first virtual object and the second virtual object belong to a same group within the virtual environment, and the second virtual object has a statistic that is higher than a statistic of the first virtual object.

17. The method according to claim 1, further comprising:
when a transformation release condition is satisfied, transforming the second virtual object back into the first virtual object, the transformation release condition including at least one of expiration of a countdown, change of login state, or movement into a virtual space that does not support transformation; and
outputting for display a transformation waiting duration indicating elapsed time since the second virtual object was transformed back into the first virtual object, wherein transformation of the first virtual object into the second virtual object is prohibited until the transformation waiting duration reaches a target waiting duration.

18. The method according to claim 1, further comprising:
when at least two groups in the virtual environment are merged into a target group, receiving an object selection operation to designate a transformable virtual object from the target group; and
when a merge duration of the target group does not reach a target duration, outputting for display a selection error message indicating that no transformable virtual object can be designated.

19. An apparatus for interaction in a virtual environment, the apparatus comprising:
processing circuitry configured to:
output for display, in the virtual environment, a first virtual object controlled by a first account;
when a second virtual object controlled by a second account is not present in the virtual environment and an object transformation instruction is received, transform the first virtual object into the second virtual object based on the object transformation instruction; and
based on an interaction instruction directed to the second virtual object controlled by the first account, control the second virtual object to interact with a third virtual object in the virtual environment.

20. A non-transitory computer-readable storage medium storing instructions which, when executed by a processor, cause the processor to perform:
outputting for display, in a virtual environment, a first virtual object controlled by a first account;
when a second virtual object controlled by a second account is not present in the virtual environment and an object transformation instruction is received, transforming the first virtual object into the second virtual object based on the object transformation instruction; and
based on an interaction instruction directed to the second virtual object controlled by the first account, controlling the second virtual object to interact with a third virtual object in the virtual environment.
